(19) United States
(12) Patent Application Publication
(10) Pub. No.: US 2024/0309141 A1
(43) Pub. Date: Sep. 19, 2024

(54) MODIFIED VINYL ALCOHOL POLYMER, MODIFIED VINYL ALCOHOL POLYMER PRODUCTION METHOD, PARTICLES, AQUEOUS SOLUTION, COATING LIQUID, COATED ARTICLE, MOLDED PRODUCT, RELEASE PAPER, DISPERSANT, VINYL POLYMER PRODUCTION METHOD, AND MIXTURE

(71) Applicant: Kuraray Co., Ltd., Okayama (JP)

(72) Inventor: Shinsuke Nii, Kurashiki-shi, Okayama (JP)

(73) Assignee: Kuraray Co., Ltd., Okayama (JP)

(21) Appl. No.: 18/268,573

(22) PCT Filed: Dec. 22, 2021
(86) PCT No.: PCT/JP2021/047743

§ 371 Date: Jun. 20, 2023

(30) Foreign Application Priority Data
Dec. 24, 2020 (JP) 2020-215063
Jul. 9, 2021 (JP) 2021-114078
Jul. 9, 2021 (JP) 2021-114079

(51) Int. Cl. C08F 261/04; C08F 2/20; C08F 8/42; C08J 3/24; C09D 129/04; C09J 7/40

(52) U.S. Cl. CPC C08F 261/04; C08F 8/42; C08J 3/242; C08J 3/247; C08F 2/20; C08J 2329/04; C09D 129/04; C09J 7/401; C09J 2429/005

(57) ABSTRACT

A modified vinyl alcohol polymer having a structural unit represented by the following formula (1), and having a water-insoluble content of 1,000 ppm or less. In the formula (1), X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents, e.g., an alkyl group having 1 to 20 carbon atoms; and n represents an integer of 0 to 6).

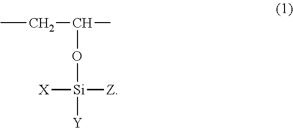

### TECHNICAL FIELD

The present disclosure relates to: a modified vinyl alcohol polymer; a method for producing a modified vinyl alcohol polymer; particles; an aqueous solution; a coating liquid; a coated article; a molded product; a release paper; a dispersant; a method for producing a vinyl polymer; and a mixture.

### BACKGROUND ART

Vinyl alcohol polymers (hereinafter, “vinyl alcohol polymer” may be abbreviated to “PVA”) have water solubility, and are used in various intended usages such as synthetic fiber materials, film materials, emulsion dispersants, adhesives, and the like.

PVAs are typically obtained by saponifying a vinyl ester polymer obtained by polymerizing a vinyl ester monomer. It is known that by saponifying modified vinyl ester polymers obtained by copolymerizing vinyl ester monomers with monomers having various functional groups, modified PVAs having special functions can be obtained.

On the other hand, various “post-modification” methods have been reported, in which reactants having various functional groups are allowed to react with PVAs after saponification, whereby functional groups derived from the reactants are incorporated into the PVAs. For example, post-modification, such as an example in which dicarboxylic acid is used as a modifying agent (Patent Document 1), is utilized as a useful technique for producing a modified PVA.

In addition, a composition for anti-fogging (Patent Document 2), a resin composition (Patent Document 3), a fiber treatment agent (Patent Document 4), and the like, each being prepared by mixing a PVA or a derivative thereof with a silane coupling agent, have been reported.

Furthermore, Patent Document 5 discloses a method in which a modified PVA is obtained by a reaction of a PVA with a specific silane coupling agent.

However, Patent Documents 1 to 5 do not disclose a modified PVA which is more superior in handleability and able to be applied to many intended usages, while having a polymer structure in which a silane coupling agent is incorporated into a PVA. For example, in a case of using a modified PVA low in water solubility as, e.g., a coating liquid or a dispersant for suspension polymerization, it may take time to allow sufficient dissolution, an insoluble content may have an undesired effect, and/or the like. Furthermore, in Patent Document 5, the reaction of the PVA with the specific silane coupling agent is conducted in an aqueous solution, and the modified PVA is obtained in the form of a solution. Improvements are expected for such a solution-form modified PVA in terms of handleability, storability, transportability, and the like. Moreover, in a case in which the solution-form modified PVA is made into a particle form by, e.g., drying, a crosslinking reaction proceeds in a drying step, whereby the water solubility tends to decrease.

Furthermore, in the paper field, PVAs are used as a paper strengthening agent, a dispersant for a fluorescent white pigment, and a binder for an inorganic substance (calcium carbonate, clay, silica, and the like). Since PVAs are superior in a film-forming property, a barrier property against gas and the like and/or oil resistance can be imparted by applying a PVA to paper.

A paper having a PVA applied thereon is sometimes used as a barrier paper, and a base paper for release paper can be given as a representative example of the barrier paper. The base paper for release paper is typically produced by applying a PVA on the surface of a cellulose base. Then, the release paper is obtained by forming a release layer (silicone layer) on the surface of this base paper for release paper. The PVA in the release paper serves the role as a filling agent which inhibits the penetration of high-cost silicone or platinum into the base. In recent years, in addition to such fillability, there is a demand for the base paper for release paper to enable, e.g., promoting curing of the silicone of the release layer, and enhancing adhesiveness between the PVA layer and the silicone layer.

Patent Document 6 discloses a base paper for release paper to which a PVA having a silyl group satisfying certain conditions has been applied. Furthermore, Patent Document 7 discloses a PVA in which a double bond is incorporated into a side chain by an acetalization reaction. However, these Documents 6 and 7 do not have disclosures regarding a coating liquid which is superior in silicone curability and adhesiveness to a base.

Furthermore, PVAs are also widely utilized as dispersants, and are utilized, for example, as a dispersion stabilizer for suspension polymerization and emulsion polymerization of a vinyl compound. In particular, PVAs are useful as a dispersion stabilizer used in suspension polymerization of vinyl chloride.

A polyvinyl chloride resin (hereinafter, “polyvinyl chloride resin” may be abbreviated to “PVC resin”) to be obtained is used in a wide range of intended usages as various materials for mold processing, due to being not only superior in chemical resistance and an electrical insulation property but also superior in processability, and due to being capable of being either rigid or soft. PVC resins are typically produced on an industrial scale by a suspension polymerization procedure in which an oil-soluble polymerization initiator is used to polymerize a vinyl chloride monomer in the presence of a dispersion stabilizer in an aqueous medium.

In many cases, a PVA is used as the dispersion stabilizer to be used in polymerization of vinyl chloride, and with the purpose of improving stability (polymerization stability) during the polymerization of the vinyl chloride, use of a PVA having an ethylenic double bond has been proposed (Patent Document 8). However, Patent Document 8 does not disclose a dispersant containing a modified PVA having a specific structure derived from a silane coupling agent.

### PRIOR ART DOCUMENTS

### Patent Documents

Patent Document 1: PCT International Publication No. 2007/119735
Patent Document 2: Japanese Unexamined Patent Application, Publication No. S48-47939
Patent Document 3: Japanese Unexamined Patent Application, Publication No. 2002-275338
Patent Document 4: Japanese Unexamined Patent Application, Publication No. H6-16738
Patent Document 5: Japanese Unexamined Patent Application, Publication No. H3-119002
Patent Document 6: Japanese Unexamined Patent Application, Publication No. 2005-194672
Patent Document 7: Japanese Unexamined Patent Application (Translation of PCT Application), Publication No. 2013-531136
Patent Document 8: Japanese Unexamined Patent Application (Translation of PCT Application), Publication No. 2019/181915

### SUMMARY OF THE INVENTION

### Problems to be Solved by the Invention

It is an object of the present disclosure to provide: a modified vinyl alcohol polymer which is superior in handleability and useful in various intended usages, while having a polymer structure in which a silane coupling agent is incorporated; a method for producing the modified vinyl alcohol polymer: particles of the modified vinyl alcohol polymer; and an aqueous solution of the modified vinyl alcohol polymer.

Furthermore, it is also an object of the present disclosure to provide: a coating liquid which enables forming a coating layer which is superior in silicone curability and adhesiveness to a base; a coated article including a base having the coating liquid applied thereto; a molded product; and a release paper.

Moreover, it is also an object of the present disclosure to provide: a dispersant which, by being used in a production step of a vinyl polymer, enables, in a vinyl polymer to be obtained: an average particle diameter to be small, an amount of coarse particles to be low, and fisheyes to be few in number; a method for producing the vinyl polymer; and a mixture.

### Means for Solving the Problems

The present invention includes the following embodiments:
(1) A modified vinyl alcohol polymer having a structural unit represented by the following formula (1), and having a water-insoluble content of 1,000 ppm or less,

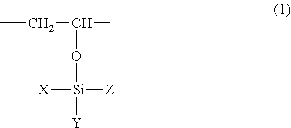

wherein, in the formula (1),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, or a glycidyl group; and n represents an integer of 0 to 6):
(2) The modified vinyl alcohol polymer according to (1), wherein a content of the structural unit represented by the above formula (1) is 0.01 mol % or more and less than 5 mol %;
(3) The modified vinyl alcohol polymer according to (1) or (2), wherein a content of the structural unit represented by the above formula (1) with respect to total structural units containing a silicon atom is 90 mol % or more;
(4) A method for producing a modified vinyl alcohol polymer, the method including impregnating, with a silane coupling agent, a vinyl alcohol polymer that is in a solid state;
(5) The method for producing a modified vinyl alcohol polymer according to (4), wherein in the impregnating, particles of the vinyl alcohol polymer are impregnated by spraying a solution containing the silane coupling agent;
(6) The method for producing a modified vinyl alcohol polymer according to (4) or (5), wherein the silane coupling agent has a structure represented by the following formula (2),

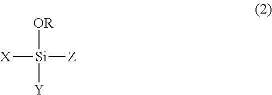

wherein, in the formula (2),
R represents an alkyl group having 1 to 8 carbon atoms, an acetyl group, or —(CH₂)ₘ—O—R² (wherein R² represents an alkyl group having 1 to 20 carbon atoms, and m represents an integer of 1 to 6); and
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents an alkyl group having 1 to 20 carbon atoms, an alkenyl group having 2 to 20 carbon atoms, an acryloyl group, a methacryloyl group, or a glycidyl group; and n represents an integer of 0 to 6);
(7) The method for producing a modified vinyl alcohol polymer according to (4), (5), or (6), further including heat treating the vinyl alcohol polymer which is impregnated with the silane coupling agent and obtained in the impregnating;
(8) Particles containing the modified vinyl alcohol polymer according to (1), (2), or (3);
(9) The particles according to (8), wherein a dispersity A of silicon atoms is 0.2 or more and less than 1;
(10) An aqueous solution containing the modified vinyl alcohol polymer according to (1), (2), or (3);
(11) A coating liquid containing a modified vinyl alcohol polymer having a structural unit represented by the following formula (1):

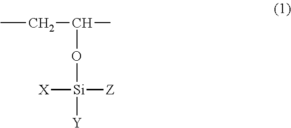

wherein, in the formula (1),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, or a glycidyl group; and n represents an integer of 0 to 6);
(12) The coating liquid according to (11), wherein a content of the structural unit represented by the above formula (1) in the modified vinyl alcohol polymer is 0.01 mol % or more and less than 5 mol %;
(13) The coating liquid according to (11) or (12), wherein in the modified vinyl alcohol polymer, a content of the structural unit represented by the above formula (1) with respect to total structural units containing a silicon atom is 90 mol % or more;
(14) The coating liquid according to (11), (12), or (13), wherein the modified vinyl alcohol polymer has a viscosity-average degree of polymerization of 500 or more and 5,000 or less, and a degree of saponification of 70 mol % or more and 99.9 mol % or less;
(15) The coating liquid according to any one of (11) to (14), wherein a water-insoluble content in the modified vinyl alcohol polymer in the coating liquid is 1,000 ppm or less;
(16) A coated article including a base having the coating liquid according to any one of (11) to (15) applied thereto;
(17) A molded product including a layer containing a modified vinyl alcohol polymer having a structural unit represented by the following formula (1′):

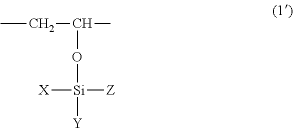

wherein, in the formula (1′),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, a glycidyl group, or an atomic bond; and n represents an integer of 0 to 6):
(18) A release paper including: a base; a silicone filling layer; and a release layer, wherein the silicone filling layer contains a modified vinyl alcohol polymer having a structural unit represented by the following formula (1′):

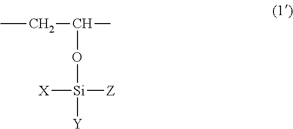

wherein, in the formula (1′),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, a glycidyl group, or an atomic bond; and n represents an integer of 0 to 6);
(19) The release paper according to (18), wherein the release layer contains addition-type silicone and platinum, and a content of the platinum with respect to 100 parts by mass of the addition-type silicone is 0.001 to 0.05 parts by mass;
(20) A dispersant containing a modified vinyl alcohol polymer having a structural unit represented by the following formula (1):

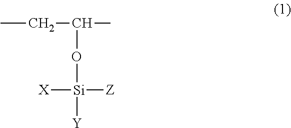

wherein, in the formula (1),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, or a glycidyl group; and n represents an integer of 0) to 6):
(21) The dispersant according to (20), wherein a content of the structural unit represented by the above formula (1) in the modified vinyl alcohol polymer is 0.01 mol % or more and less than 5 mol %;
(22) The dispersant according to (20) or (21), wherein in the modified vinyl alcohol polymer, a content of the structural unit represented by the above formula (1) with respect to total structural units containing a silicon atom is 90 mol % or more;
(23) The dispersant according to (20), (21), or (22), wherein the modified vinyl alcohol polymer has a viscosity-average degree of polymerization of 500 or more and 1,500 or less, and a degree of saponification of 60 mol % or more and 90 mol % or less;
(24) The dispersant according to any one of (20) to (23), wherein a water-insoluble content in the modified vinyl alcohol polymer is 1,000 ppm or less;
(25) The dispersant according to any one of (20) to (24), which is for use in suspension polymerization;
(26) A method for producing a vinyl polymer, the method including subjecting a vinyl compound to suspension polymerization in the presence of the dispersant according to any one of (20) to (25); and
(27) A mixture containing: a vinyl compound; and the dispersant according to any one of (20) to (25).

### Effects of the Invention

The present disclosure enables providing: a modified vinyl alcohol polymer which is superior in handleability and useful in various intended usages, while having a polymer structure in which a silane coupling agent is incorporated; a method for producing the modified vinyl alcohol polymer: particles of the modified vinyl alcohol polymer; and an aqueous solution of the modified vinyl alcohol polymer.

Furthermore, the present disclosure enables providing: a coating liquid which enables forming a coating layer superior in silicone curability and adhesiveness to a base; a coated article including a base having the coating liquid applied thereto; a molded product; and a release paper.

Moreover, the present disclosure also enables providing: a dispersant which, by being used in a production step of a vinyl polymer, enables, in a vinyl polymer to be obtained: an average particle diameter to be small, an amount of coarse particles to be low, and fisheyes to be few in number; a method for producing the vinyl polymer; and a mixture.

### DESCRIPTION OF EMBODIMENTS

### Modified Vinyl Alcohol Polymer (Modified PVA)

The modified PVA of the present disclosure has a structural unit represented by the following formula (1), and has a water-insoluble content of 1,000 ppm or less.

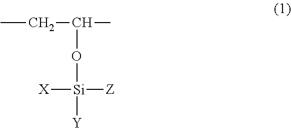

In the formula (1), X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, or a glycidyl group; and n represents an integer of 0 to 6).

Due to the water-insoluble content being low and water solubility being superior while having the polymer structure in which the silane coupling agent is incorporated, the modified PVA of the present disclosure is superior in handleability, and useful in various intended usages. More specifically, since the modified PVA of the present disclosure is easily dissolved in a case of being used in the form of a coating liquid or an aqueous solution such as a dispersant for suspension polymerization, and further, since undissolved matter is low in amount, the modified PVA is easily handleable. Since the modified PVA of the present disclosure is superior in water solubility, the modified PVA is particularly useful in various intended usages involving being used after dissolving in water, such as a coating liquid, a dispersant for suspension polymerization, and the like. Furthermore, the modified PVA, thus being superior in water solubility, is superior in handleability also in view of enabling storage, transportation, and the like in a particle (powder) state, and being dissolved in water and easily used.

Examples of the alkyl group having 1 to 20 carbon atoms which may be represented by X, Y, Z, or R¹ include a methyl group, an ethyl group, a propyl group, a butyl group, an isobutyl group, a hexyl group, a lauryl group, and the like. The number of carbon atoms in these alkyl groups is preferably 1 to 6, and more preferably 1 to 3.

Examples of the alkenyl group having 2 to 20 carbon atoms which may be represented by X, Y, Z, or R¹ include a vinyl group, an allyl group, a hexenyl group, an oleyl group, and the like. The number of carbon atoms in these alkenyl groups is preferably 2 to 6, and more preferably 2 to 3. As the alkenyl group, a vinyl group is particularly preferred. The vinylphenyl group which may be represented by X, Y, or Z means a group represented by CH₂═CH—C₆H₄—.

Examples of the halogen contained in the halogenated alkyl group having 1 to 20 carbon atoms or the halogenated phenyl group, each of which may be represented by X, Y, or Z, include chlorine, bromine, fluorine, and the like. The number of carbon atoms in the halogenated alkyl group is preferably 1 to 6, and more preferably 1 to 3.

The aminoalkyl group having 1 to 20 carbon atoms which may be represented by X, Y, or Z is typically a group represented by NR₂-Cₙₐ—H₂ₙₐ— (wherein each R independently represents a hydrogen atom or a hydrocarbon group having 1 to 6 carbon atoms; and na is an integer of 1 to 20). The number of carbon atoms in this aminoalkyl group is preferably 1 to 10, and more preferably 1 to 6.

The mercaptoalkyl group having 1 to 20 carbon atoms which may be represented by X, Y, or Z is typically a group represented by HS—C_{nb}—H_{2nb}— (wherein nb is an integer of 1 to 20). The number of carbon atoms in this mercaptoalkyl group is preferably 1 to 6. The mercaptoalkyl group is particularly preferably a mercaptopropyl group.

The ureidoalkyl group having 2 to 20 carbon atoms which may be represented by X, Y, or Z is typically a group represented by NH₂CONH—C_{nc}H_{2nc}— (wherein nc is an integer of 1 to 19). The number of carbon atoms in this ureidoalkyl group is preferably 2 to 6.

The isocyanate alkyl group having 2 to 8 carbon atoms which may be represented by X, Y, or Z is typically a group represented by OCN—C_{nd}—H_{2nd}— (wherein nd is an integer of 1 to 7). The number of carbon atoms in this isocyanate alkyl group is preferably 2 to 6.

The group having 3 to 20 carbon atoms and containing an epoxy group which may be represented by X, Y, or Z means a group having 3 to 20 carbon atoms and containing a cyclic ether structure having a 3-membered ring. Examples of such a group include an epoxy group, a glycidyl group, a glycidoxymethyl group, a 3-glycidoxypropyl group, a 2-(3,4-epoxy cyclohexyl)ethyl group, and the like. The number of carbon atoms in this epoxy group-containing group is preferably 3 to 12.

Examples of the group having 3 to 20 carbon atoms and containing an acrylamide group which may be represented by X, Y, or Z include an acrylamide group, an acrylamidomethyl group, a 3-acrylamidopropyl group, an N-(2-acrylamidoethyl)-aminopropyl group, a (3-acrylamidopropyl)-oxypropyl group, and the like. The number of carbon atoms in this group containing an acrylamide group is preferably 3 to 12.

Examples of the group having 4 to 20 carbon atoms and containing a methacrylamide group which may be represented by X, Y, or Z include a methacrylamide group, a methacrylamidomethyl group, a 3-methacrylamidopropyl group, an N-(2-methacrylamidoethyl)-aminopropyl group, a (3-methacrylamidopropyl)-oxypropyl group, and the like. The number of carbon atoms in this group containing a methacrylamide group is preferably 4 to 12.

The group represented by —(CH₂)ₙ—O—R¹ is preferably a (meth)acryloxyalkyl group, and preferably a methacryloxypropyl group.

The alkali metal atom which may be represented by R¹ is preferably a lithium atom, a sodium atom, a potassium atom, a rubidium atom, a cesium atom, or a francium atom.

The alkaline earth metal which may be represented by R¹ is preferably a magnesium atom, a calcium atom, a strontium atom, or a barium atom.

It is preferable that at least one of X, Y, and Z represents the alkenyl group having 2 to 20 carbon atoms, the mercaptoalkyl group having 1 to 20 carbon atoms, or the group represented by —(CH₂)ₙ—O—R¹.

X, Y, and Z may each preferably represent the alkyl group having 1 to 20 carbon atoms, the alkenyl group having 2 to 20 carbon atoms, a phenyl group, a benzyl group, a vinylphenyl group, the halogenated alkyl group having 1 to 20 carbon atoms, the halogenated phenyl group, the aminoalkyl group having 1 to 20 carbon atoms, the mercaptoalkyl group having 1 to 20 carbon atoms, the ureidoalkyl group having 2 to 20 carbon atoms, the isocyanate alkyl group having 2 to 8 carbon atoms, the group having 3 to 20 carbon atoms and containing the acrylamide group, the group having 4 to 20 carbon atoms and containing the methacrylamide group, an acetoxy group, or the group represented by —(CH₂)ₙ—O—R¹, may each more preferably represent the alkyl group having 1 to 20 carbon atoms, the alkenyl group having 2 to 20 carbon atoms, a phenyl group, a benzyl group, or the group represented by —(CH₂)ₙ—O—R¹, and may each still more preferably represent the alkenyl group having 2 to 20 carbon atoms or the group represented by —(CH₂)ₙ—O—R¹. n may be preferably an integer of 0) to 4, and may be preferably an integer of 0) to 2.

The water-insoluble content of the modified PVA in the present disclosure is 1,000 ppm or less. The upper limit of this water-insoluble content is preferably 500 ppm, more preferably 200 ppm, and still more preferably 100 ppm, 70 ppm, 50 ppm, or 10 ppm. Due to the water-insoluble content thus being low; the modified PVA is superior in handleability and can achieve superior effects when used in a coating liquid, a dispersant, and/or the like. The lower limit of this water-insoluble content may be 0) ppm, and may be 1 ppm. The water-insoluble content as referred to in the present disclosure means a mass proportion of a component which remains undissolved after the modified PVA is charged in water so as to have a concentration of 5% by mass, and then stirred at 90° C. for 60 min.

More specifically, a 500 mL flask equipped with an agitator and a reflux condenser is placed in a water bath set to 20° C. Distilled water in an amount of 285 g is charged into the flask, and stirring is started at 300 rpm. After weighing out 15 g of a modified PVA, the modified PVA is gradually charged into the flask. When an entirety of the PVA (15 g) has been charged, the modified PVA is dissolved by elevating a temperature of the water bath to 90° C. over a time period of 30 min to give a solution of the modified PVA. After the temperature of the water bath reaches 90° C., the dissolution is continued while further stirring for 60 min at 300 rpm. Thereafter, the modified PVA solution is used to filter undissolved, a residual solid of the modified PVA (hereinafter, may be referred to as “undissolved solids” or “undissolved particles”) with a metal filter having a mesh opening size of 63 μm. Next, the filter is washed with hot water at 90° C. to remove the modified PVA solution attached to the filter to retain only the undissolved solids on the filter, and then the filter is dried for 1 hour with a heating drier at 120° C. A mass of the filter after the drying and a mass of the filter before being used for the filtering are compared to calculate a mass of the undissolved solids. A proportion of the mass of the undissolved solids with respect to the mass (15 g) of the modified PVA initially charged into the water is defined as the water-insoluble content.

The modified PVA of the present disclosure is a polymer having a vinyl alcohol unit as a main structural unit. The lower limit of a proportion of the vinyl alcohol unit with respect to total structural units in the modified PVA is, for example, preferably 30 mol %, more preferably 50 mol %, still more preferably 65 mol %, and may be yet more preferably 70 mol %, 80 mol %, 85 mol %, 90 mol %, or 95 mol %. On the other hand, the upper limit of the proportion of the vinyl alcohol unit is, for example, preferably 99.9 mol %, more preferably 99 mol %, and may be still more preferably 98 mol %, 95 mol %, 90 mol %, 85 mol %, or 80 mol %. The modified PVA of the present disclosure is obtained by, for example, allowing for a reaction (post-modification) of a silane coupling agent represented by the formula (2), described later, with a PVA in the presence of an acid catalyst, thereby allowing an —OR group in the silane coupling agent to react with an —OH group in the PVA.

The lower limit of a degree of modification of the modified PVA with a silane coupling agent-derived functional group is preferably 0.01 mol %, more preferably 0.1 mol %, and still more preferably 0.2 mol %. When the degree of modification with the silane coupling agent-derived functional group is more than or equal to the lower limit, the effect of the silane coupling agent-derived functional group in the modified PVA is more easily expressed. On the other hand, the upper limit of the degree of modification with the silane coupling agent-derived functional group is preferably 5 mol %, more preferably 3 mol %, and still more preferably 1 mol %. When the degree of modification with the silane coupling agent-derived functional group is less than or equal to the upper limit, the water solubility of the modified PVA tends to be more superior.

It is to be noted that the “degree of modification” in the present disclosure means, in the modified PVA, a proportion of the total number of moles of the functional group derived from the silane coupling agent incorporated by post-modification, with respect to the number of moles of the total structural units contained in the modified PVA, and may be referred to as the “degree of modification with the silane coupling agent-derived functional group” or simply the “degree of modification”. It is to be noted that in the present specification, a structure represented by —CR′₂—CR′₂— is considered to be one structural unit. Each R′ independently represents a hydrogen atom or an arbitrary substituent, and two R's contained in the same or different structural units may be bonded to each other. For example, the structural unit represented by the above formula (1) is considered to consist of one structural unit. On the other hand, for example, each structural unit derived from the vinyl alcohol unit, a residual vinyl ester unit, or another monomer is considered to consist of one structural unit. In other words, a structure corresponding to a monomer having a carbon-carbon double bond, used in polymerization, is a structural unit.

The degree of modification with the silane coupling agent-derived functional group can be determined by ¹H-NMR measurement of the modified PVA. For example, in the case of the modified PVA obtained by using trimethoxyvinylsilane and a PVA that is a saponification product of polyvinyl acetate, the modified PVA is dissolved in DMSO-do and measured using ¹H-NMR at 400 MHZ. A peak derived from a hydrogen atom contained in the hydroxy group of the vinyl alcohol unit and a peak derived from a hydrogen atom bonded to a carbon atom to which the acetoxy group of the vinyl acetate unit bonds are attributed to 4.2 to 5.2 ppm (integrated value a). A peak derived from three hydrogen atoms contained in the vinyl group of trimethoxyvinylsilane is attributed to around 5.8 to 6.2 (integrated value B). The degree of modification with the silane coupling agent-derived functional group is calculated from these integrated values in accordance with the following equation.

degree of modification with silane coupling agent-derived functional group (mol %)={β/(3α+β)}×100

Also in the case of using another silane coupling agent, the degree of modification can similarly be determined based on peaks derived from groups which do not react in the silane coupling agent.

The lower limit of a content of the structural unit represented by the above formula (1) in the modified PVA of the present disclosure is preferably 0.01 mol %, more preferably 0.1 mol %, and still more preferably 0.2 mol %. When the content of the structural unit represented by the above formula (1) is more than or equal to the lower limit, the effect resulting from incorporating the silane coupling agent in the modified PVA may be more easily expressed. On the other hand, the content of the structural unit represented by the above formula (1) is preferably less than 5 mol %. The upper limit of the content of the structural unit represented by the above formula (1) is more preferably 3 mol %, still more preferably 2 mol %, and yet more preferably 1 mol %. When the content of the structural unit represented by the above formula (1) is less than the upper limit or less than or equal to the upper limit, the water solubility and the handleability of the modified PVA tend to be more superior, and performance when used in, e.g., a coating liquid and a dispersant for suspension polymerization tends to be more superior. The content of the structural unit represented by the above formula (1) can be determined by ¹H-NMR measurement of the modified PVA, similar to that for the degree of modification. For example, with respect to a modified PVA obtained in each of Examples, described later, it is speculated that the degree of modification and the content of the structural unit represented by the above formula (1) are substantially equal.

In the modified PVA of the present disclosure, the lower limit of the content of the structural unit represented by the above formula (1) with respect to total structural units containing a silicon atom is preferably 90 mol % and more preferably 99 mol %, and the content may be substantially 100 mol %. For example, in a case of allowing for a reaction of the PVA with a silane coupling agent having an epoxy group in a solution in the presence of a certain catalyst, the epoxy group and the hydroxy group in the PVA react. In such a case, a structural unit containing a silicon atom, being different from the structural unit represented by the above formula (1), is formed, and a desired effect may not be sufficiently achieved. In contrast, in the case of making the content of the structural unit represented by the above formula (1) with respect to the total structural units containing a silicon atom be more than or equal to the lower limit, the modified PVA may have superior water solubility, and may be more suitable for a coating liquid, a dispersant, and/or the like.

In the modified PVA, the lower limit of a block character of residual vinyl ester units is preferably 0.30, and more preferably 0.40. On the other hand, the upper limit of the block character is preferably 1, and more preferably 0.8. When the block character falls within the above range, production of the modified PVA may be facilitated.

It is to be noted that the above-described block character is a numerical value representing a distribution of residual ester groups and hydroxy groups formed by saponification of ester groups, and can fall within a numerical range between 0) and 2. 0 indicates that residual ester groups or hydroxy groups are distributed completely as blocks, and as the value increases, alternation increases: 1 indicates that residual ester groups and hydroxy groups are present completely at random, and 2 indicates that residual ester groups and hydroxy groups are present completely alternately. The “residual ester group” as referred to means an ester group (—O—C(═O)-Q (where Q represents a hydrocarbon group contained in the vinyl ester monomer, other than a part being CH₂═CH—O—C(═O)) contained in the vinyl ester monomer unit in the modified PVA to be obtained by a saponification treatment. In a case in which the modified PVA contains structural unit(s) other than the vinyl ester monomer unit and/or the vinyl alcohol unit, the block character is calculated for all the sequences of the vinyl ester monomer unit and/or the vinyl alcohol unit in the modified PVA.

The lower limit of a degree of saponification of the modified PVA is preferably 30 mol %, more preferably 65 mol %, and may be still more preferably 70 mol %, 80 mol %, or 90 mol %. On the other hand, the upper limit of the degree of saponification of the modified PVA is preferably 99.9 mol %, more preferably 99 mol %, and may be still more preferably 98 mol %, 93 mol %, 90 mol %, or 85 mol %. When the degree of saponification of the modified PVA falls within the above range, the modified PVA can be obtained having more superior water solubility. The degree of saponification of the modified PVA and a raw material PVA, described later, are measured in accordance with a procedure disclosed in JIS-K6726-1994.

The lower limit of a viscosity-average degree of polymerization of the modified PVA (hereinafter, may be also referred to as merely “degree of polymerization”) is preferably 100, more preferably 300, and may be still more preferably 500, 600, 650, 700, or 1,000. On the other hand, the upper limit thereof is preferably 5,000, more preferably 4,000, and may be still more preferably 3,000, 2,000, 1,500, 1,000, or 800. The viscosity-average degree of polymerization is measured in accordance with a procedure disclosed in JIS-K6726-1994.

The modified PVA of the present disclosure may be used in a variety of intended usages. Examples thereof are given below; but the intended usages of the modified PVA of the present disclosure are not limited thereto.
(1) Vinyl chloride dispersant usages: dispersion stabilizers and dispersion aids for suspension polymerization of vinyl chloride or vinylidene chloride;
(2) Coating material usages: sizing agents, fiber processing agents, leather finishers, paints, anti-fogging agents, metal corrosion inhibitors, gloss agents for galvanized substance(s), and antistatic agents;
(3) Adhesive/binder usages: adhesives, agglutinants, remoistenable adhesives, various binders, and additives for cements, mortars, etc.;
(4) Dispersion stabilizer usages: dispersion stabilizers for organic/inorganic pigments for paints, adhesives, etc., dispersion stabilizers for emulsion polymerization of various vinyl compounds, and post emulsifiers for bitumen, etc.;
(5) Paper processing usages: paper strengthening agents, agents for imparting oil resistance/solvent resistance, smoothness-improving agents, surface gloss-improving aids, wood fillers, barrier agents, agents for imparting light resistance, water-proofing agents, dye/developer dispersants, adhesiveness improving agents, and binders;
(6) Agricultural usages: binders for pesticides, spreaders for pesticides, agricultural coating materials, soil improving agents, erosion inhibitors, and dispersants for pesticides;
(7) Medical/cosmetic usages: granulate binders, coating agents, emulsifying agents, skin patches, binding agents, bases for film formulations, and film-forming agents;
(8) Viscosity adjusting agent usages: thickening agents and rheology-adjusting agents;
(9) Aggregating agent usages: agents for aggregating solids suspended in water and for dissolved matter, and metal aggregating agents;
(10) Film usages: water-soluble films, polarized films, barrier films, films for wrapping textile products, seed germination sheets, vegetation sheets, seed tapes, and hygroscopic films;
(11) Molded article usages: fibers, pipes, tubes, anti-leak films, water-soluble fibers for chemical laces, and sponges;
(12) Usages as raw materials for resins: raw materials for polyvinyl butyral, raw materials for photosensitive resins, raw materials for graft polymers, and raw materials for various gels; and
(13) Post-reaction usages: post-reaction usages with low-molecular organic compounds, high-molecular organic compounds, and inorganic compounds.

Of these, as described later, the dispersant and the coating liquid for, e.g., paper processing usages are suitable intended usages of the modified PVA of the present disclosure. Furthermore, the film usages are also preferred, and film usages for unit wrapping are more preferred.

### Particles

One embodiment of the modified PVA of the present disclosure is particles (modified PVA particles). The particles of the present disclosure are particles containing the modified PVA. The particles are superior in water solubility and handleability, and are useful in various intended usages. For example, a coating liquid can be efficiently obtained by using the particles. Furthermore, the particles can also be effectively used as a dispersant. The particles may substantially consist of only the modified PVA. A content of the modified PVA in the particles is, for example, 90% by mass or more, may be 99% by mass or more, and may be 100% by mass.

An average particle diameter (dp50) of the particles of the present disclosure is, for example, preferably 100 μm or more and 5 mm or less, more preferably 200 μm or more and 3 mm or less, and still more preferably 300 μm or more and 1 mm or less. When the average particle diameter falls within the above range, the handleability and the like tend to further improve. The average particle diameter (dp50) is calculated by using a JIS standard sieve to measure a particle size distribution by a dry sieve procedure disclosed in JIS-Z8815-1994, and plotting the result in accordance with the Rosin-Rammler distribution equation.

A dispersity A of silicon atoms in the particles is preferably 0.2 or more and less than 1. The dispersity A of the silicon atoms in the particles is a proportion, when the modified PVA is in a particulate state, of a silicon atom content in central parts of the particles with respect to a silicon atom content on surfaces of the particles, and is an indicator of the degree of dispersion of the silane coupling agent-derived functional group. Specifically, the dispersity A is measured by the following procedure.

First, 10 particles each being almost spherical and having a particle diameter of 100 μm or more are selected. Each particle is separated in two such that a cross sectional area is maximal, an inscribed circle of the cross section is defined as a center of the particle, a point of contact between the inscribed circle and a particle surface portion is defined as a particle surface, and a silicon atom content is measured by using an energy dispersive X-ray spectroscopy apparatus (EDS). With respect to each particle, the dispersity A in each particle is determined based on the following equation, and an average value of the 10 particles is taken.

dispersity A=silicon atom content in central part of particle (mol %)/silicon atom content on surface of particle (mol %)

The lower limit of the dispersity A is preferably 0.2, more preferably 0.5, still more preferably 0.7, still more preferably 0.8, and yet more preferably 0.9. Furthermore, the dispersity A may be less than 1, and the upper limit value may be 0.99. When the dispersity A falls within the above range, the degree of dispersion of the silane coupling agent-derived functional group in the polymer or in the particles of the modified PVA can be more favorable, and the water solubility and the handleability of the modified PVA can be made further superior. Moreover, as a result of the dispersity A falling within the above range and the water solubility being high, favorable use in a coating liquid, a dispersant, and/or the like can be enabled, whereby the performance as a coating liquid, a dispersant, and/or the like can be enhanced.

### Aqueous Solution

The aqueous solution of the present disclosure contains the modified PVA of the present disclosure. Since the modified PVA is low in insoluble content, the aqueous solution of the present disclosure can be favorable used as a coating liquid or the like. In other words, the coating liquid, described later, and the like are modes of the aqueous solution. The aqueous solution can be obtained by dissolving the modified PVA in water by a conventionally well-known procedure.

The aqueous solution of the present disclosure does not contain the silane coupling agent or further contains the silane coupling agent, and a proportion of a content of silicon atoms contained in the modified PVA with respect to a total content of silicon atoms contained in the modified PVA and the silane coupling agent may be preferably 50 mol % or more. The lower limit of the proportion of silicon atoms is more preferably 70 mol %, 90 mol %, or 95 mol %. When the content of the silane coupling agent in the aqueous solution is thus low; storage stability, reaction uniformity, and the like of the aqueous solution tend to be improved.

In the aqueous solution, substantially only the modified PVA may be contained as the solute. A proportion of the modified PVA with respect to total solute in the aqueous solution is preferably 50% by mass or more, more preferably 70% by mass or more, still more preferably 90% by mass or more, and yet more preferably 95% by mass or more. A concentration of the modified PVA in the aqueous solution is appropriately set in accordance with the intended usage and the like, and may be, for example, 0.1% by mass or more and 30% by mass or less, and may be 1% by mass or more and 25% by mass or less. A solvent other than water may be contained in the aqueous solution.

### Method for Producing Modified PVA

The modified PVA can be produced by, for example, saponifying a vinyl ester polymer, resulting from polymerizing a vinyl ester monomer, to give a PVA, and then allowing for a reaction of the PVA with the silane coupling agent.

Examples of the vinyl ester monomer include vinyl formate, vinyl acetate, vinyl propionate, vinyl valerate, vinyl caprate, vinyl laurate, vinyl stearate, vinyl benzoate, vinyl pivalate, vinyl versatate, and the like. Of these, vinyl acetate is preferred.

A procedure of polymerizing the vinyl ester monomer is exemplified by a well-known procedure such as a bulk polymerization procedure, a solution polymerization procedure, a suspension polymerization procedure, an emulsion polymerization procedure, and the like. Of these procedures, the bulk polymerization procedure performed without a solvent and the solution polymerization procedure performed with a solvent such as an alcohol are preferred, and in light of enhancing the effects of the present disclosure, the solution polymerization procedure in which the polymerization is performed in the presence of a lower alcohol is more preferred. The lower alcohol is preferably an alcohol having 3 or fewer carbon atoms; more preferably methanol, ethanol, n-propanol, or isopropanol; and still more preferably methanol. In carrying out a polymerization reaction by the bulk polymerization procedure or the solution polymerization procedure, in terms of a reaction system, either of a batchwise system or a continuous system can be employed.

An initiator to be used in the polymerization reaction is exemplified by well-known initiators, e.g., azo initiators such as 2,2-azobisisobutyronitrile, 2,2-azobis(2,4-dimethylvaleronitrile), and 2,2′-azobis(4-methoxy-2,4-dimethylvaleronitrile); organic peroxide initiators such as benzoyl peroxide and n-propyl peroxycarbonate; and the like. A polymerization temperature at a time of carrying out the polymerization reaction is not particularly limited, and a range of 5° C. or more and 200° C. or less is appropriate.

In polymerizing the vinyl ester monomer, a copolymerizable monomer can be further copolymerized within a range not impairing the principles of the present disclosure. Furthermore, the copolymerizable monomer may be the silane coupling agent. Examples of such a monomer include: α-olefins such as ethylene, propylene, 1-butene, isobutene, and 1-hexene; acrylamide derivatives such as N-methylacrylamide and N-ethylacrylamide; methacrylamide derivatives such as N-methylmethacrylamide and N-ethylmethacrylamide; vinyl ethers such as methyl vinyl ether, ethyl vinyl ether, n-propyl vinyl ether, isopropyl vinyl ether, and n-butyl vinyl ether; hydroxyl group-containing vinyl ethers such as ethylene glycol vinyl ether, 1,3-propanediol vinyl ether, and 1,4-butanediol vinyl ether; allyl acetate; allyl ethers such as propyl allyl ether, butyl allyl ether, and hexyl allyl ether; oxvalkylene group-containing monomers; isopropenyl acetate; hydroxy group-containing α-olefins such as 3-buten-1-ol, 4-penten-1-ol, 5-hexen-1-ol, 7-octen-1-ol, 9-decen-1-ol, and 3-methyl-3-buten-1-ol; silyl group-containing monomers such as vinyltrimethoxysilane, vinylmethyldimethoxysilane, vinyldimethylmethoxysilane, vinyltriethoxysilane, vinylmethyldiethoxysilane, vinyldimethylethoxysilane, 3-(meth)acrylamidopropyltrimethoxysilane, and 3-(meth)acrylamidopropyltriethoxysilane; and the like. The upper limit of an amount of these monomers to be used may vary depending on the object of usage, the intended usage, and the like, but with respect to total monomers, is preferably 20 mol %, and more preferably 10 mol %.

In the saponification reaction of the vinyl ester polymer obtained in the polymerizing step, an alkali catalyst or an acid catalyst may be used, and for example, an alcoholysis or hydrolysis reaction using a conventionally well-known basic catalyst such as sodium hydroxide, potassium hydroxide, or sodium methoxide can be adopted. Examples of the solvent to be used in the saponification reaction include: alcohols such as methanol and ethanol; esters such as methyl acetate and ethyl acetate; ketones such as acetone and methyl ethyl ketone; aromatic hydrocarbons such as benzene and toluene; and the like. These can be used alone, or as a combination of two or more types thereof. Of these, due to convenience, it is preferable to use as the solvent, methanol or a mixed solution of methanol and methyl acetate, and to conduct the saponification reaction in the presence of sodium hydroxide that serves as the basic catalyst. Through such a procedure, the PVA can be obtained.

In light of further inhibiting excessive crosslinking of the modified PVA to be obtained, a viscosity of a 4% by mass aqueous solution of the PVA before being reacted with the silane coupling agent (hereinafter, may be referred to as “raw material PVA”) is preferably 1 mPa·s or more and 200 mPa·s or less, more preferably 2 mPa·s or more and 100 mPa·s or less, and still more preferably 3 mPa·s or more and 50 mPa·s or less.

The lower limit of a degree of saponification of the raw material PVA is preferably 30 mol %, more preferably 60 mol %, still more preferably 65 mol %, and may be yet more preferably 70 mol %, 80 mol %, or 90 mol %. On the other hand, the upper limit of the degree of saponification of the raw material PVA is preferably 99.9 mol %, more preferably 99 mol %, and may be still more preferably 98 mol %, 93 mol %, 90 mol %, or 85 mol %. When the degree of saponification of the raw material PVA falls within the above range, the reaction with the silane coupling agent can be expected to proceed more efficiently.

The lower limit of a degree of polymerization of the raw material PVA is preferably 100, more preferably 300, and may be still more preferably 500, 600, 650, 700, or 1,000. On the other hand, the upper limit is preferably 5,000, more preferably 4,000, and may be still more preferably 3,000, 2,000, 1,500, 1,000, or 800.

For example, by allowing for a reaction (post-modification) of a raw material PVA such as that described above with the silane coupling agent, the modified PVA can be obtained.

As the silane coupling agent, a compound represented by the following formula (2) is preferably used.

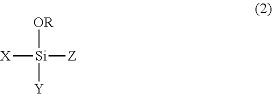

In the formula (2), R represents an alkyl group having 1 to 8 carbon atoms, an acetyl group, or —(CH₂)ₘ—O—R² (wherein R² represents an alkyl group having 1 to 20 carbon atoms, and m represents an integer of 1 to 6); and X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents an alkyl group having 1 to 20 carbon atoms, an alkenyl group having 2 to 20 carbon atoms, an acryloyl group, a methacryloyl group, or a glycidyl group; and n represents an integer of 0 to 6).

R in the formula (2) represents preferably an alkyl group having 1 to 8 carbon atoms, and more preferably an alkyl group having 1 to 3 carbon atoms. As specific modes and suitable modes of X, Y, and Z in the formula (2), the specific modes and suitable modes of X, Y, and Z in the formula (1) may be exemplified.

Examples of the compound represented by the formula (2) include vinyltrimethoxysilane, vinylmethyldimethoxysilane, vinyldimethylmethoxysilane, vinyltriethoxysilane, vinylmethyldiethoxysilane, vinyldimethylethoxysilane, allyltrimethoxysilane, allylmethyldimethoxysilane, allyldimethylmethoxysilane, allyltriethoxysilane, allylmethyldiethoxysilane, allyldimethylethoxysilane, vinyl-tris(β-methoxyethoxy)silane, vinylisobutyldimethoxysilane, vinylethyldimethoxysilane, vinylmethoxydibutoxysilane, vinyldimethoxy butoxysilane, vinyltributoxysilane, vinylmethoxydihexyloxysilane, vinyldimethoxy hexyloxysilane, vinyltrihexyloxysilane, vinylmethoxydioctyloxysilane, vinyldimethoxyoctyloxysilane, vinyltrioctyloxysilane, vinylmethoxydilauryloxysilane, vinyldimethoxylauryloxysilane, vinylmethoxydioleyloxysilane, vinyldimethoxyoleyloxysilane, 3-(meth)acrylamide-propyltrimethoxysilane, 3-(meth)acrylamide-propyltriethoxysilane, 3-(meth)acrylamide-propyltri(β-methoxyethoxy)silane, 2-(meth)acrylamide-ethyltrimethoxysilane, 1-(meth)acrylamide-methyltrimethoxysilane, 2-(meth)acrylamide-2-methylpropyltrimethoxysilane, 2-(meth)acrylamide-isopropyltrimethoxysilane, N-(2-(meth)acrylamide-ethyl)-aminopropyltrimethoxysilane. (3-(meth)acrylamide-propyl)-oxypropyltrimethoxysilane, 3-(meth)acrylamide-propyltriacetoxysilane, 2-(meth)acrylamide-ethyltriacetoxysilane, 4-(meth)acrylamide-butyltriacetoxysilane, 3-(meth)acrylamide-propyltripropiony loxysilane, 2-(meth)acrylamide-2-methylpropyltriacetoxysilane, N-(2-(meth)acrylamide-ethyl)-aminopropyltriacetoxysilane, 3-(meth)acrylamide-propylisobutyldimethoxysilane, 2-(meth)acrylamide-ethyldimethylmethoxysilane, 3-(meth)acrylamide-propylmethyldiacetoxysilane, 2-(meth)acrylamide-2-methylpropyl hydrogendimethoxysilane, 3-(N-methyl-(meth)acrylamide)-propyltrimethoxysilane, 2-(N-ethyl-(meth)acrylamide)-ethyltriacetoxysilane, p-styryltrimethoxysilane (a silane coupling agent having a vinylphenyl group), 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, 3-aminopropyltrimethoxysilane, 3-aminopropyltriethoxysilane, N-phenyl-3-aminopropyltrimethoxysilane, 3-ureidopropyltrimethoxysilane, 3-ureidopropyltriethoxysilane, 3-isocyanate propyltriethoxysilane, 3-mercaptopropylmethyldimethoxysilane, 3-mercaptopropyltrimethoxysilane, and the like. Of these, vinyltrimethoxysilane may be preferably used in light of ease of industrial production and availability at low cost. For example, the OR group in the silane coupling agent represented by the above formula (2) and the OH group in the PVA can cause a condensation reaction, whereby the structural unit represented by the formula (1) can be formed, enabling the modified PVA to be obtained.

The lower limit of an amount of addition of the silane coupling agent with respect to 100 parts by mass of the PVA is preferably 0.1 parts by mass, more preferably 0.5 parts by mass, and still more preferably 1 part by mass. On the other hand, the upper limit of the amount of addition of the silane coupling agent with respect to 100 parts by mass of the PVA is preferably 20 parts by mass, more preferably 15 parts by mass, and still more preferably 10 parts by mass. When the amount of addition of the silane coupling agent falls within the above range, the water solubility and the handleability of the modified PVA to be obtained can be further enhanced.

A procedure for allowing for a reaction of the PVA with the silane coupling agent is not particularly limited, and for example, the desired reaction can be allowed to proceed by mixing the PVA in powder or particle form with a solution containing the silane coupling agent by using a ribbon blender, a Henschel mixer, a V blender, a rotary kiln, a planetary mixer, a high-speed mixer, a Henschel mixer, a turbulizer, a Lödige mixer, or the like. Furthermore, one embodiment of the present disclosure is a method for producing the modified PVA, the method including a step of impregnating, with a silane coupling agent, a vinyl alcohol polymer that is in a solid state.

Furthermore, one embodiment of the present disclosure is a method for producing the modified PVA, wherein in the impregnating step, the PVA is impregnated (permeated) by spraying a solution containing the silane coupling agent.

In the impregnating step, a solvent is preferably used such that the silane coupling agent disperses through the PVA uniformly. In other words, a method involving a solvent (solution) containing the silane coupling agent being added to the PVA particles, and a mixture consisting of the PVA and the silane coupling agent being allowed to react is preferred. At this time, an amount of addition of the solvent is not limited, and 10 to 50 parts by mass with respect to 100 parts by mass of the PVA is preferred. When the amount of addition of the solvent falls within the above range, the silane coupling agent can permeate the PVA particles more uniformly and the reaction of the silane coupling agent with the PVA can proceed more uniformly, whereby the water solubility and the handleability of the modified PVA to be obtained tend to be further improved.

An average particle diameter (dp50) of the PVA particles used in the impregnating step is, for example, preferably 100 μm or more and 5 mm or less, more preferably 200 μm or more and 3 mm or less, and still more preferably 300 μm or more and 1 mm or less. When such a size of PVA particles is used, the silane coupling agent tends to permeate the PVA particles more uniformly, whereby the water solubility and the handleability of the modified PVA to be obtained tend to be further improved.

Furthermore, in the impregnating step, an acidic catalyst is preferably used. Examples of acidic catalysts which can be used include inorganic acids such as sulfuric acid, hydrochloric acid, and phosphoric acid, and organic acids such as acetic acid and p-toluenesulfonic acid, but since using a catalyst with a high degree of acidity may result in a saponification reaction of the PVA proceeding, using an acidic catalyst having an acid dissociation constant pKa of 4 to 6 is preferred. Of these, using acetic acid is preferred.

As a solvent which may be used in the impregnating step, a polar solvent having high affinity to the PVA is preferred. For example, various solvents such as: alcohols such as methanol, ethanol, and isopropanol; ketones such as acetone, ethyl methyl ketone, and diethyl ketone; esters such as methyl acetate and ethyl acetate; dimethylsulfoxide; N,N-dimethylformamide; and the like may be used. Of these, methanol and methyl acetate are preferred.

Furthermore, one embodiment of the method for producing the modified PVA of the present disclosure further includes a step of heat treating the PVA which is impregnated with the silane coupling agent and obtained in the impregnating. By this heat treatment, the reaction of the silane coupling agent with the PVA sufficiently occurs. In the case of subjecting the PVA impregnated with the silane coupling agent to the heat treatment, since drying is involved, a dehydrative condensation reaction is promoted between the OR group in the silane coupling agent and the OH group in the PVA, whereby formation of the structural unit represented by the above formula (1) sufficiently occurs. It is to be noted that in the case of subjecting a solution containing the silane coupling agent and the PVA to the heat treatment, it is considered that the dehydrative condensation reaction will not sufficiently proceed, and formation of the structural unit represented by the above formula (1) will, for the most part, not occur.

A means of performing the heat treatment is not particularly limited, and for example, the heat treatment may be performed using a drier, and the heat treatment is preferably conducted using a hot air drier. Furthermore, the impregnating step and the heat-treating step may be conducted concurrently, and for example, the heat treatment may be performed while mixing the PVA in powder or particle form with a solution containing the silane coupling agent by using a ribbon blender, a Henschel mixer, a V blender, a rotary kiln, a planetary mixer, a high-speed mixer, a Henschel mixer, a turbulizer, a Lödige mixer, or the like.

In the step of heat treating the PVA and the silane coupling agent, the lower limit of a heat treatment temperature (reaction temperature) is preferably 20° C., more preferably 40° C., still more preferably 60° C., yet more preferably 75° C., and particularly preferably 80° C. On the other hand, the upper limit of the heat treatment temperature is preferably 120° C., more preferably 110° C., and still more preferably 100° C. When the heat treatment temperature falls within the above range, the reaction can proceed more favorably, and furthermore, the water solubility and the handleability of the modified PVA to be obtained can be further enhanced.

In the heat-treating step, a heat treatment time period may be appropriately set in accordance with the heat treatment temperature, and is preferably 1 hr or more and 18 hrs or less, and more preferably 3 hrs or more and less than 12 hrs. Furthermore, at a heat treatment temperature of 70° C. or more and 90° C. or less, the reaction is preferably allowed for 3 hrs or more and less than 12 hrs.

By the above-described production method, the silane coupling agent permeates the PVA that is in the solid state and the PVA swells, and due to the reaction of the PVA with the silane coupling agent proceeding in this state, uneven distribution of the silane coupling agent-derived functional group in the modified PVA is inhibited, and consequently, particles of the modified PVA can be obtained having a higher dispersity A. Furthermore, such a modified PVA has a lower water-insoluble content and the water solubility and handleability are more superior, whereby application in many intended usages is further facilitated. For example, in the case of using the modified PVA in a coating liquid, a dispersant, or the like, superior performance as the coating liquid, the dispersant, or the like can be achieved.

### Coating Liquid

The coating liquid of the present disclosure contains the modified PVA having the structural unit represented by the above formula (1). The coating liquid of the present disclosure is preferably a coating liquid for a paper base or a film base, and may be a coating liquid used in producing a release paper or a mold release film. The coating liquid can form a coating layer superior in silicone curability and adhesiveness to a base. Furthermore, the coating layer formed from the coating liquid also has sufficient fillability. Except for not requiring that the water-insoluble content is 1,000 ppm or less, specific modes and suitable modes of the modified PVA used in the coating liquid are similar to those of the modified PVA of the present disclosure, described above. However, the water-insoluble content of the modified PVA used in the coating liquid preferably falls within the range described above.

A viscosity-average degree of polymerization of the modified PVA used in the coating liquid of the present disclosure is not particularly limited, and the lower limit thereof is preferably 500, more preferably 600, and may be still more preferably 650. When the lower limit of the viscosity-average degree of polymerization of the modified PVA falls within the above range, air resistance of the coating layer formed from the coating liquid containing the modified PVA can improve, and the fillability tends to improve. Furthermore, the upper limit of the viscosity-average degree of polymerization is preferably 5,000, more preferably 4,000, still more preferably 3,000, and may be yet more preferably 2,000. When the upper limit of the viscosity-average degree of polymerization of the modified PVA falls within the above range, the producibility of the modified PVA can be further enhanced. Moreover, the viscosity-average degree of polymerization of the modified PVA is preferably 500 or more and 5,000 or less.

The lower limit of a degree of saponification of the modified PVA used in the coating liquid of the present disclosure is preferably 70 mol %, more preferably 80 mol %, and may be still more preferably 90 mol %. On the other hand, the upper limit of the degree of saponification of the modified PVA is preferably 99.9 mol %. When the degree of saponification of the modified PVA falls within the above range, the modified PVA can be obtained being superior in water solubility and in film water resistance after coating and drying, and performance as a coating liquid can be more superior.

The upper limit of the insoluble content of the modified PVA in the coating liquid is preferably 1,000 ppm, more preferably 500 ppm, still more preferably 200 ppm, yet more preferably 100 ppm, particularly preferably 70 ppm, more particularly preferably 50 ppm, and still more particularly preferably 10 ppm. Furthermore, the lower limit of the insoluble content of the modified PVA in the coating liquid is preferably 0 ppm, and may be 1 ppm. It is to be noted that the insoluble content of the modified PVA in the coating liquid as referred to in the present disclosure means a mass proportion of modified PVA-derived component(s) which remain undissolved in the coating liquid, and is specifically measured in accordance with the following procedure.

The coating liquid is passed through a metal filter having a mesh opening size of 63 μm and the filter is further washed with hot water at 90° C. to give a modified PVA solid in the coating liquid which remains undissolved. A proportion of the mass of the undissolved modified PVA solid with respect to the mass of the modified PVA contained in the coating liquid before the filtering is calculated, and this is defined as the insoluble content of the modified PVA in the coating liquid.

The lower limit of a concentration of the modified PVA in the coating liquid is preferably 2% by mass, and may be more preferably 5% by mass. Furthermore, the upper limit of the concentration of the modified PVA in the coating liquid is preferably 30% by mass, and may be more preferably 25% by mass. When the concentration of the modified PVA in the coating liquid falls within the above range, coating efficiency may further improve, and fast-coatability may be further superior.

The coating liquid of the present disclosure does not contain the silane coupling agent or further contains the silane coupling agent, and a proportion of a content of silicon atoms contained in the modified PVA with respect to a total content of silicon atoms contained in the modified PVA and the silane coupling agent may be preferably 50 mol % or more. The lower limit of the proportion of silicon atoms is more preferably 70 mol %, 90 mol %, or 95 mol %. When the content of the silane coupling agent in the coating liquid is thus low; storage stability, reaction uniformity, and the like of the coating liquid tend to be improved.

The coating liquid of the present disclosure is preferably an aqueous solution containing the modified PVA. In this case, the aqueous solution may contain a small amount of an organic solvent, and/or may contain a small amount of organic particles and/or inorganic particles which are water insoluble. A concentration of the modified PVA in the aqueous solution is preferably 1% by mass or more and 30% by mass or less.

A method for producing the coating liquid of the present disclosure is not particularly limited. For example, the coating liquid can be obtained by dissolving particles of the modified PVA in water.

The coating liquid may contain, within a range not impairing the effects of the present disclosure, another component aside from the vinyl alcohol polymer of the present disclosure. Examples of the other component may include: aqueous dispersive resins such as SBR latex, NBR latex, vinyl acetate emulsions, ethylene/vinyl acetate copolymer emulsions, (meth)acrylic ester emulsions, and vinyl chloride emulsions; raw starches obtained from wheat, corn, rice, potato, sweet potato, tapioca, and sago palm; decomposition products of raw starches such as oxidized starch and dextrin; starch derivatives such as etherified starch, esterified starch, and cationized starch; cellulose derivatives such as methylcellulose, hydroxyethylcellulose, and carboxymethylcellulose (CMC); monosaccharides such as glucose, fructose, isomerized sugar, and xylose; disaccharides such as maltose, lactose, sucrose, trehalose, palatinose, reduced maltose, reduced palatinose, and reduced lactose; oligosaccharides such as starch syrup, isomalto-oligosaccharide, fructo-oligossaccharide, lacto-oligosaccharide, soy bean oligosaccharide, xylo-oligosaccharide, coupling sugar, and cyclodextrine compounds; polysaccharides such as pullulan, pectin, agar, konjac mannan, polydextrose, and xanthan gum; albumin; gelatin; casein; gum arabic; polyamide resins; melamine resins; poly(meth)acrylamide; polyvinylpyrrolidone; sodium poly(meth)acrylate; anion-modified PVA; sodium alginate; water-soluble polyesters; and the like.

A content of these components in the coating liquid is typically 10% by mass or less

The coating liquid may contain, within a range not impairing the effects of the present disclosure, a pigment. Examples of the pigment include inorganic pigments (e.g., clay, kaolin, aluminum hydroxide, calcium carbonate, and talc) and organic pigments (e.g., plastic pigments) typically used in in the field of coating paper production. A content of these pigment components in the coating liquid is preferably 50% by mass or less.

### Coated Article

A suitable embodiment of the present invention is a coated article including a base having the coating liquid applied to a surface thereof. The base is preferably a paper base or a film base. A method for producing the coated article is not particularly limited, and may be, for example, a production method including: a step of applying the coating liquid to the base; and a step of drying the base after the applying.

As the paper base, well-known paper or synthetic paper obtained by subjecting to papermaking; a chemical pulp such as hardwood kraft pulp or softwood kraft pulp; a mechanical pulp such as GP (ground pulp), RGP (refiner ground pulp), or TMP (thermomechanical pulp); and/or the like may be used. Furthermore, as the paper base, a wood-free paper, a medium-quality paper, an alkaline paper, a glassine paper, or a semi-glassine paper; a paperboard or white paperboard used for, e.g., cardboard, building materials, white chipboard, or chipboard; or the like may be used. It is to be noted that an organic or inorganic pigment, and/or a papermaking aid such as a paper-strengthening agent, a sizing agent, and/or a yield-improving agent may be contained in the paper base. Furthermore, the paper base may be subjected to various surface treatments.

The film base is preferably a film base consisting of a thermoplastic resin. Examples of the thermoplastic resin include polyolefins, polyesters, polyamides, and the like.

Examples of coating equipment include a 2-roll size press, a gate roll size press, a metering size press, an air knife coater, a bar coater, a roll coater, a blade coater, and the like. A coating speed is preferably 100 to 2,000 m/min. Furthermore, the coating speed is more preferably 300 m/min or more, and may be more preferably 1,800 m/min or less. When the coating speed falls within the above range, production efficiency can be further improved, and furthermore, coating in a more uniform manner can be further facilitated. A coating amount can be selected ad libitum in accordance with characteristics of the paper, and about 0.05 to 10 g/m² per side of the paper is suitable.

The drying after the coating can be performed, for example, by hot air, infrared radiation, a heated cylinder, or a procedure in which these are combined. Barrier properties of the dried coated article can be further improved by performing humidity conditioning and calendering. As conditions for the humidity conditioning, conditions such that a moisture percentage in the paper is 5 to 20% by mass are desirable. Furthermore, as conditions for the calendering, a roll temperature is preferably room temperature to 200° C., and a linear load of the rolls is preferably 20 to 350 kg/cm.

The lower limit of the air resistance of the coated article is preferably 400 sec, more preferably 2,000 sec, still more preferably 5,000 sec, yet more preferably 7,000 sec, and may be particularly preferably 10,000 sec. The upper limit of the air resistance is not particularly limited, and may be 20,000 sec.

Examples of the coated article include a base paper for release paper, a barrier paper, an oil-resistant paper, a packaging paper, paperboard, a polyethylene-based mold release film, a polypropylene-based mold release film, a polyester-based mold release film, and the like. Of these, the base paper for release paper including a paper base having the coating liquid applied to the surface thereof is a suitable embodiment. A mold release layer (release layer) may be formed on the surface of the base paper for release paper. In forming the mold release layer, solvent-based silicone, non-solvent-based (emulsion-based, oligomer-based) silicone, or the like may be suitably used. Since a solvent (toluene or the like) is contained in the solvent-based silicone, the base paper for release paper of the present disclosure preferably has barrier properties against solvents. Furthermore, in the case of using the non-solvent-based silicone, since water resistance is required, the base paper for release paper of the present disclosure preferably has water resistance. In the present disclosure, a release paper having: the base paper for release paper; and the mold release layer formed on the surface of the base paper for release paper is also a suitable embodiment.

### Molded Product

One embodiment of the present disclosure is a molded product including a layer containing a modified PVA having a structural unit represented by the following formula (1′).

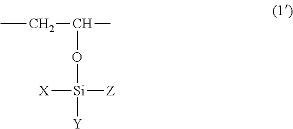

In the formula (1′), X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and containing an epoxy group, a group having 3 to 20 carbon atoms and containing an acrylamide group, a group having 4 to 20 carbon atoms and containing a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, a glycidyl group, or an atomic bond; and n represents an integer of 0 to 6).

Except for including the case in which R¹ represents an atomic bond, in other words, except for the point that a cross-linked structure may be formed, specific modes and suitable modes of the structural unite represented by the formula (1′) are similar to the specific modes and suitable modes of the structure unit represented by the above-described formula (1). Furthermore, except for the point that a cross-linked structure may be formed, described above, specific modes and suitable modes of the modified PVA contained in the molded product are similar to the specific modes and suitable modes of the modified PVA used in, e.g., the coating liquid of the present disclosure.

The molded product is not particularly limited, and for example, may be a structure having a three-dimensional shape, or may be a sheet-shaped product. Materials constituting the molded product are not particularly limited, and may be exemplified by metals, ceramic, glass, resins, concrete, and the like. Examples of the metals include iron, steel, aluminum, stainless steel, gold, silver, copper, and the like. Furthermore, the molded product may be the above-described base, and as the base, the paper base or the film base is preferred.

The layer containing the modified PVA in the molded product may be a coating film formed by applying the above-described coating liquid on the applicable molded product.

A content of the modified PVA in the layer containing the modified PVA may be, for example, 50% by mass or more and 100% by mass, or less, or may be 70% by mass or more and 99.9% by mass or less. The layer containing the modified PVA may further contain other component(s) aside from the modified PVA. Examples of the other component(s) include the various components which may be contained in the coating liquid, described above.

### Release Paper

One embodiment of the present invention is a release paper. The release paper includes a base, a silicone filling layer, and a release layer, and the silicone filling layer contains the structural unit represented by the above formula (1′). In the release paper, the base, the silicone filling layer, and the release layer are preferably laminated in this order. The release paper of the present disclosure is one mode of the molded product of the present disclosure. In other words, the silicone filling layer which is included in the release layer of the present disclosure corresponds to the layer containing the modified PVA in the above-described molded product.

The release layer preferably contains addition-type silicone and platinum, and a content of platinum with respect to 100 parts by mass of the addition-type silicone is preferably 0.001 to 0.05 parts by mass. Thus, curability of the addition-type silicone in the release layer can be further improved. Furthermore, since a curing speed of the addition-type silicone can be promoted, a time period required for a silicone-curing step can be shortened. Alternatively, a reduction in production cost can be expected due to, e.g., enabling a reduction in a usage amount of the platinum.

The base in the release paper can be exemplified by the above-described base, and the paper base and the film base are suitably employed. It is to be noted that in the present disclosure, for example, even in a case in which the base is constituted from only the film base in the release paper including the base, the silicone filling layer, and the release layer, this may be referred to as the “release paper”.

### Dispersant

The dispersant of the present disclosure contains the modified PVA having the structural unit represented by the above formula (1). A vinyl polymer produced using the dispersant has a small average particle diameter, the amount of coarse particles is small, and fisheyes are few in number. Except for the water-insoluble content being 1,000 ppm or less not being required, specific modes and suitable modes of the modified PVA used in the dispersant are similar to those of the modified PVA of the present disclosure, described above. However, the water-insoluble content of the modified PVA used in the dispersant preferably falls within the above-described range.

A content of the modified PVA in the dispersant of the present disclosure is preferably 50% by mass or more, more preferably 80% by mass or more, still more preferably 90% by mass or more, and may be yet more preferably 95% by mass or more. Furthermore, the content of the modified PVA in the dispersant may be 100% by mass, i.e., the dispersant may be substantially constituted from only the modified PVA.

The dispersant of the present disclosure is preferably a dispersant for suspension polymerization, and may be a dispersant to be used in subjecting a vinyl compound to suspension polymerization.

The dispersant may be in particle form. Furthermore, the dispersant may be in a state of being dissolved in water. In other words, one embodiment of the present disclosure is an aqueous solution containing the dispersant and water.

A degree of polymerization of the modified PVA used in the dispersant of the present invention is not particularly limited, and the lower limit thereof, for example, may be 300, and is preferably 500, more preferably 600, and may be still more preferably 650. Furthermore, the upper limit of the degree of polymerization, for example, may be 3,000, and is preferably 1,500, more preferably 1,000, and may be still more preferably 800. Moreover, a viscosity-average degree of polymerization of the modified PVA is preferably 500 or more and 1,500 or less. When the degree of polymerization of the modified PVA falls within the above range, in the case in which the dispersant containing the modified PVA is used as a dispersant for subjecting a vinyl compound to suspension polymerization, a proportion of coarse particles in the vinyl polymer to be obtained can be lower, and furthermore, when the vinyl polymer to be obtained in made into a sheet shape, fisheyes can be reduced.

The lower limit of a degree of saponification of the modified PVA used in the dispersant of the present disclosure is preferably 30 mol %, more preferably 60 mol %, and may be still more preferably 80 mol %. On the other hand, the upper limit of the degree of polymerization of the modified PVA is preferably 99.9 mol %, more preferably 99 mol %, still more preferably 98 mol %, yet more preferably 93 mol %, particularly preferably 90 mol %, and may be more particularly preferably 85 mol %. When the degree of saponification of the modified PVA falls within the above range, the water solubility can increase, and the performance as the dispersant for suspension polymerization can be more superior. For example, the degree of saponification of the modified PVA is preferably 60 mol % or more and 90 mol % or less. When the degree of saponification of the modified PVA falls within the above range, since, e.g., surface active performance can be made suitable, in the case of using the modified PVA as the dispersant, vinyl polymer particles having smaller particle diameters can be produced. Furthermore, when the degree of saponification is less than or equal to the upper limit, plasticizer absorptivity of the vinyl polymer particles to be obtained using the modified PVA as the dispersant can be further improved.

The dispersant of the present disclosure may include, within a range not impairing the principles of the present invention, any of various types of additives. Examples of the additives include: polymerization modifiers such as aldehydes, halogenated hydrocarbons, and mercaptans; polymerization inhibitors such as phenol compounds, sulfur compounds, and N-oxide compounds; pH modifiers; crosslinking agents; antiseptic agents; mildew-proofing agents; anti-blocking agents; defoaming agents; compatibilizers; and the like. A content of the various types of additives in the dispersant with respect to the dispersant in total is preferably 10% by mass or less, and may be more preferably 5% by mass or less.

### Method for Producing Vinyl Polymer

One embodiment of the present disclosure is a method for producing a vinyl polymer, the method including a step of subjecting a vinyl compound to suspension polymerization in the presence of the dispersant. In the production method, the vinyl polymer to be obtained may be in particle form.

A procedure of charging the dispersant into a polymerization reactor may be exemplified by: (i) a procedure of preparing an aqueous solution with the dispersant and then charging into the polymerization reactor; and (ii) a procedure of charging in a powder state. In light of uniformity in the polymerization reactor, the procedure of (i) is preferred.

In the suspension polymerization of the vinyl compound, a usage amount (concentration) of the dispersant with respect to the vinyl compound may be 1,500 ppm or less, may be 1,000 ppm or less, or may be 800 ppm or less. The usage amount (concentration) of the dispersant with respect to the vinyl compound may be 100 ppm or more, may be 300 ppm or more, or may be 500 ppm or more. As referred to herein, ppm means parts per million on a mass basis.

Examples of the vinyl compound include: halogenated vinyls such as vinyl chloride; vinyl esters such as vinyl acetate and vinyl propionate; (meth)acrylic acid and esters and salts thereof; maleic acid, fumaric acid, and esters and anhydrides thereof; styrene, acrylonitrile, vinylidene chloride, and vinyl ether; and the like. Of these, vinyl chloride alone, or vinyl chloride together with a monomer that can be copolymerized with vinyl chloride is preferred. Examples of the monomer that can be copolymerized with vinyl chloride include: vinyl esters such as vinyl acetate and vinyl propionate; (meth)acrylic acid esters such as methyl (meth)acrylate and ethyl (meth)acrylate; α-olefins such as ethylene and propylene; unsaturated dicarboxylic acids such as maleic anhydride and itaconic acid; acrylonitrile, styrene, vinylidene chloride, and vinyl ether; and the like.

In the suspension polymerization of the vinyl compound, an oil-soluble or water-soluble polymerization initiator conventionally used in polymerization of a vinyl compound (e.g., vinyl chloride) may be used. Examples of the oil-soluble polymerization initiator include: percarbonate compounds such as diisopropyl peroxy dicarbonate, di-2-ethylhexyl peroxy dicarbonate, and diethoxyethyl peroxy dicarbonate; perester compounds such as t-butyl peroxyneodecanoate, t-butyl peroxypivalate, t-hexyl peroxypivalate, and cumyl peroxyneodecanoate; peroxides such as acetylcyclohexylsulfonyl peroxide, 2,4,4-trimethylpentyl-2-peroxyphenoxyacetate, 3,5,5-trimethylhexanoyl peroxide, and lauroyl peroxide; azo compounds such as 2,2-azobis (2,4-dimethylvaleronitrile), 2,2′-azobis(isobutyonitrile), and 2,2′-azobis (4-methoxy-2,4-dimethylvaleronitrile) and the like. Examples of the water-soluble polymerization initiator include potassium persulfate, ammonium persulfate, hydrogen peroxide, cumene hydroperoxide, and the like. These polymerization initiators may be used either alone of one type, or in a combination of two or more types.

In the suspension polymerization of the vinyl compound, a polymerization temperature is not particularly limited, and may be a low temperature of about 20° C. or a high temperature of more than 90° C., and of these, about 40 to 70° C. is preferred. Furthermore, a polymerization vessel equipped with a reflux condenser may be used in order to enhance heat removal efficiency of the polymerization reaction system.

The dispersant may be used alone in the suspension polymerization of the vinyl compound, but within a range not impairing the principles of the present invention, the dispersant may be used together with, for example: a water-soluble cellulose ether such as methyl cellulose, hydroxyethyl cellulose, hydroxypropyl cellulose, hydroxyethylmethyl cellulose (HEMC), or hydroxypropylmethyl cellulose (HPMC); a water-soluble polymer such as a modified (for example, modified by an ionizable group such as carboxylic acid or sulfonic acid) or unmodified polyvinyl alcohol other than the modified PVA, or gelatin; an oil-soluble emulsifying agent such as sorbitan monolaurate, sorbitan triolate, glycerin tristearate, or an ethylene oxide-propylene oxide block polymer: a water-soluble emulsifying agent such as polyoxyethylene sorbitan monolaurate, polyoxyethylene glycerine olate, or sodium laurate; or the like.

Examples of the polyvinyl alcohol other than the modified PVA include a polyvinyl alcohol (S) having a degree of saponification of less than 65 mol % and a viscosity-average degree of polymerization of 50 to 750, a polyvinyl alcohol (T) having a degree of saponification of 65 mol % or more and 99.5 mol % or less and a viscosity-average degree of polymerization of 800 to 3,500, and the like. These degrees of saponification and viscosity-average degrees of polymerization can be measured similarly to those of the modified PVA. The polyvinyl alcohol (S) is preferably a polyvinyl alcohol having a degree of saponification of 30 to 60 mol % and a viscosity-average degree of polymerization of 180 to 650. The polyvinyl alcohol (T) is preferably a polyvinyl alcohol having a degree of saponification of 80 mol % or more and 99.5 mol % or less and a viscosity-average degree of polymerization of 1,000 to 3,200. Furthermore, the polyvinyl alcohol (S) and the polyvinyl alcohol (T) may be unmodified, or may be imparted with a self-emulsifying property by means of modification by incorporating an ionizable group such as carboxylic acid or sulfonic acid. A mass ratio (modified PVA/polyvinyl alcohol (S)) of the polyvinyl alcohol (S) used together with the modified PVA is not particularly limited, and is preferably 95/5 to 20/80, and may be more preferably 90/10 to 30/70. A mass ratio (modified PVA/polyvinyl alcohol (T)) of the polyvinyl alcohol (T) used together with the modified PVA is not particularly limited, and is preferably 95/5 to 20/80, and may be more preferably 90/10 to 30/70. The modified PVA and the polyvinyl alcohol (S) and/or the polyvinyl alcohol (T) may be charged at once at an initial stage of the suspension polymerization, or may be charged in fractions during the suspension polymerization.

A plasticizer or the like can be appropriately blended into the vinyl polymer to enable usage in various molded products.

### Mixture

One embodiment of the present disclosure is a mixture containing a vinyl compound and a dispersant. The mixture may further contain water. For example, in the method for producing a vinyl polymer, the mixture may be a reaction liquid containing the vinyl compound before performing the suspension polymerization, the dispersant, and water; or may be a reaction liquid after conducting the suspension polymerization. Furthermore, one embodiment of the present disclosure is a mixture containing the vinyl polymer and the dispersant. The mixture may further contain water. For example, in the method for producing a vinyl polymer, the mixture may be a reaction liquid after performing the suspension polymerization.

As long as the effects of the present invention are achieved, the present invention includes, within the range of the technical idea of the present disclosure, embodiments in which the above-described features are variously combined.

### EXAMPLES

Hereinafter, the present invention is more specifically described by way of Examples. It is to be noted that “parts” and “%” have meanings on a mass basis, unless otherwise specified particularly.

### Degree of Saponification of PVA

The degree of saponification of the PVA (raw material PVA or modified PVA) is determined in accordance with a procedure disclosed in JIS-K6726-1994.

### Viscosity of 4% by Mass Aqueous Solution of Raw Material PVA

A 300 mL flask equipped with an agitator and a reflux condenser was placed in a water bath at room temperature. After charging 192 g of distilled water into the flask, stirring was started at 300 rpm. Eight grams of PVA was weighed out, and the PVA was gradually charged into the flask. When an entirety of the PVA (8 g) was charged into the flask, the temperature of the water bath was elevated to 95° C. over a time period of 30 min. After the temperature of the water bath reached 90° C., dissolution was continued while further stirring for 2 hrs at 300 rpm. Thereafter, the temperature of the water bath was brought to room temperature, and the flask was gradually cooled with stirring. An aqueous solution thus obtained was transferred to a 100 ml sample tube and the viscosity at a rotation speed of 60 rpm was measured at 20° C. by using B-type viscometer BLII (manufactured by Toki Sangyo Co., Ltd).

### Viscosity-Average Degree of Polymerization

The viscosity-average degree of polymerization of the raw material PVA or the modified PVA was measured in accordance with JIS-K6726-1994.

Degree of Modification with Silane Coupling Agent-Derived Functional Group in Modified PVA (Content of Structural Unit Represented by Above Formula (1))

The degree of modification with the silane coupling agent-derived functional group in the modified PVA (the content of the structural unit represented by the above formula (1): mol %) was determined in accordance with the above-described procedure using ¹H-NMR.

### Dispersity A of Silicon Atoms in Modified PVA Particles

With regard to the dispersity A of silicon atoms in the modified PVA particles, 10 particles each being almost spherical and having a particle diameter of 100 μm or more were selected, these particles were each separated in two such that a cross sectional area was maximal, an inscribed circle of the cross section was defined as a center of each particle, a point of contact between the inscribed circle and a particle surface portion was defined as a particle surface, the silicon atom content was measured by using an energy dispersive X-ray spectroscopy apparatus (EDS), and the dispersity A was determined based on the following equation.

dispersity A=silicon atom content in central part of particle (mol %)/silicon atom content on surface of particle (mol %)

One modified PVA particle was encapsulated with a thermosetting epoxy resin, the modified PVA particle was cut in a frozen state using UC7/FC7, a cryo-ultramicrotome (manufactured by Leica Microsystems GmbH), and a cross section of the particle was exposed and used as an observation sample. In order to conduct charge correction on the observation sample, platinum vapor deposition was performed at a thickness of about 2 nm using MC1000, manufactured by Hitachi High-Technologies Corporation. Next, a cross-sectional image of a Poval resin was taken using SU-70, a scanning electron microscope (SEM) (manufactured by Hitachi High-Technologies Corporation), and elemental analysis was performed using an energy dispersive X-ray spectroscopy apparatus (EDS, “X-Max 50)”, manufactured by Oxford Instruments plc) at an end and a central part of the particle. The image observation and elemental analysis were performed in an ultra-high vacuum. EDS analysis was performed on a secondary electron image obtained at an observation magnification of 2,500 times, an acceleration voltage of 15 kV, and a working distance of 15 mm, and an elemental composition was obtained from a spectrum thus obtained. An average value of measurement samples of 10 particles was defined as the silicon atom content.

### Water-Insoluble Content of Modified PVA

A 500 mL flask equipped with an agitator and a reflux condenser was placed in a water bath set to 20° C. After charging 285 g of distilled water into the flask, stirring was started at 300 rpm. Fifteen grams of a modified PVA was weighed out, and the modified PVA was gradually charged into the flask. When an entirety of the modified PVA (15 g) was charged into the flask, the modified PVA was dissolved by elevating a temperature of the water bath to 90° C. over a time period of 30 min to give a solution of the modified PVA. After the temperature of the water bath reached 90° C., the dissolution was continued while further stirring for 60 min at 300 rpm. Thereafter, the modified PVA solution was used to filter undissolved, residual solids of the modified PVA (undissolved particles) with a metal filter having a mesh opening size of 63 μm. Next, the filter was washed with hot water at 90° C. to remove the solution attached to the filter to retain only the dissolved solids on the filter, and then the filter was dried for 1 hour with a heating drier at 120° C. A mass of the filter after the drying and a mass of the filter before being used for the filtering were compared to calculate a mass of the undissolved solids. A proportion of the mass of the undissolved solids with respect to the mass (15 g) of the modified PVA initially charged into the water was defined as the water-insoluble content (ppm).

### Example 1

Into a 100 ml beaker were charged 3.0 parts of vinyltrimethoxysilane as a silane coupling agent, 0.13 parts of acetic acid as a catalyst, and 7.0 parts of methanol as a solvent, and a solution of vinyltrimethoxysilane in methanol was produced. Next, 100 parts of PVA particles having a viscosity in a 4% by mass aqueous solution of 5 mPa·s and a degree of saponification of 88 mol % were charged into a 1 L wide-mouthed eggplant-shaped flask, and the PVA particles were thereafter impregnated with the solution of vinyltrimethoxysilane in methanol by spraying to give a mixture of vinyltrimethoxysilane with PVA. The eggplant-shaped flask was stored (heat treated) for 4 hrs in a hot air drier at 80° C. to give a modified PVA (1) in particle form, being a reaction product with the vinyltrimethoxysilane. The modified PVA (1) thus obtained had a degree of saponification of 88 mol %, a degree of modification of 0.4 mol %, a dispersity A of 0.98, and a water-insoluble content of less than 10 ppm, and was superior in water solubility. Since the modified PVA (1) thus obtained was in the particle form and was superior in water solubility, it can be assessed as being superior in handleability.

### Examples 2 to 9, Comparative Examples 1 to 2

Modified PVAs (2) to (11) were each produced similarly to Example 1, except that the type of the raw material PVA used, the type and the usage amount of the solvent, the type and the usage amount of the silane coupling agent, the type and the usage amount of the catalyst, and the production conditions (heat treatment conditions) were changed as shown in Table 1. Results of evaluating each modified PVA obtained on the dispersity A, the degree of saponification, the degree of modification, and the water-insoluble content are shown in Table 2.

TABLE 1

| | | Raw Material PVA | | | | | | | | Production Conditions | |
|---|---|---|---|---|---|---|---|---|---|---|---|
| | | Viscosity | | | | | | | | Heat | Heat |
| | | in 4% by | Degree | Silane Coupling Agent | | | | | | treat- | treat- |
| | | mass | of | (Modification Type) | | Solvent | | Catalyst | | ment | ment |
| | | aqueous | saponi- | | Usage | | Usage | | Usage | temper- | time |
| | | solution | fication | | amount | | amount | | amount | ature | period |
| | | (mPa · s) | (mol %) | Type | (parts) | Type | (parts) | Type | (parts) | (° C.) | (hrs) |
| Example 1 | Modified | 5 | 88 | Vinyltrimethoxy- | 3.0 | MeOH | 7.0 | acetic | 0.13 | 80 | 4 |
| | PVA (1) | | | silane | | | | acid | | | |
| Example 2 | Modified | 5 | 88 | Vinyltriethoxy- | 4.0 | MeOH | 9.3 | acetic | 0.13 | 100 | 4 |
| | PVA (2) | | | silane | | | | acid | | | |
| Example 3 | Modified | 5 | 88 | p-styryltrimethoxy- | 4.6 | MeOH | 10.7 | acetic | 0.13 | 80 | 4 |
| | PVA (3) | | | silane | | | | acid | | | |
| Example 4 | Modified | 5 | 88 | 3-methacryloxy- | 5.1 | MeOH | 11.9 | acetic | 0.13 | 80 | 4 |
| | PVA (4) | | | propyltrimethoxy- | | | | acid | | | |
| | | | | silane | | | | | | | |
| Example 5 | Modified | 5 | 88 | 3-aminopropyl- | 3.7 | MeOH | 8.6 | acetic | 0.13 | 80 | 4 |
| | PVA (5) | | | trimethoxysilane | | | | acid | | | |
| Example 6 | Modified | 5 | 74 | Vinyltrimethoxy- | 2.7 | methyl | 6.3 | acetic | 0.11 | 80 | 4 |
| | PVA (6) | | | silane | | acetate | | acid | | | |
| Example 7 | Modified | 5 | 98 | Vinyltrimethoxy- | 3.3 | MeOH | 7.7 | acetic | 0.14 | 80 | 4 |
| | PVA (7) | | | silane | | | | acid | | | |
| Example 8 | Modified | 22 | 88 | Vinyltrimethoxy- | 3.0 | MeOH | 7.0 | acetic | 0.13 | 80 | 4 |
| | PVA (8) | | | silane | | | | acid | | | |
| Example 9 | Modified | 5 | 88 | vinyltrimethoxy- | 3.0 | MeOH | 7.0 | p-toluene- | 0.35 | 80 | 4 |
| | PVA (9) | | | silane | | | | sulfonic | | | |
| | | | | | | | | acid | | | |
| Comparative | Modified | 5 | 88 | Vinyltrimethoxy- | 3.0 | MeOH | 7.0 | sodium | 0.08 | 80 | 4 |
| Example 1 | PVA (10) | | | silane | | | | hydroxide | | | |
| Comparative | Modified | 5 | 88 | Vinyltrimethoxy- | 3.0 | hexane | 7.0 | sodium | 0.08 | 60 | 5 |
| Example 2 | PVA (11) | | | silane | | | | hydroxide | | | |

TABLE 2

| | Modified PVA | | | | |
|---|---|---|---|---|---|
| | | | Degree of | Degree of | Water-insoluble |
| | | Dispersity | saponification | modification | content |
| | Type | A | (mol %) | (mol %) | (ppm) |
| Example 1 | Modified PVA (1) | 0.98 | 88 | 0.4 | <10 |
| Example 2 | Modified PVA (2) | 0.96 | 88 | 0.2 | <10 |
| Example 3 | Modified PVA (3) | 0.92 | 88 | 0.3 | 50 |
| Example 4 | Modified PVA (4) | 0.95 | 88 | 0.4 | 20 |
| Example 5 | Modified PVA (5) | 0.93 | 88 | 0.5 | 40 |
| Example 6 | Modified PVA (6) | 0.96 | 74 | 0.6 | <10 |
| Example 7 | Modified PVA (7) | 0.82 | 98 | 0.2 | <10 |
| Example 8 | Modified PVA (8) | 0.92 | 88 | 0.4 | <10 |
| Example 9 | Modified PVA (9) | 0.92 | 92 | 0.3 | 250 |
| Comparative | Modified PVA (10) | 0.89 | — | — | >10,000 |
| Example 1 | | | | | |
| Comparative | Modified PVA (11) | 0.13 | 94 | 0.1 | 1,500 |
| Example 2 | | | | | |

As shown in Table 2, modified PVAs (1) to (9) of the Examples each had a water-insoluble content of 1,000 ppm or less, and were superior in water solubility. Due to having superior water solubility while having a silane coupling agent-derived functional group, such modified PVAs are superior in handleability, and can be applied to many intended usages. On the other hand, in modified PVA (10), in which the PVA and the silane coupling agent were allowed to react in an alkaline condition as in Comparative Example 1, the water-insoluble content was more than 1,000 ppm, indicating inferior water solubility; perhaps owing to crosslinking of the silane coupling agent being excessively promoted. Such a modified PVA is inferior in handleability, and application in many intended usages is difficult. Furthermore, in the case of using hexane as the solvent in the impregnating step, as in Comparative Example 2, the dispersity A of the particles of the modified PVA (11) obtained was low and the water-insoluble content was high, perhaps owing to the PVA not swelling and the silane coupling agent not favorably permeating the PVA. The modified PVA (11) was also inferior in water solubility and handleability.

### Example 10

In a 100 ml beaker, 4.8 parts of vinyltrimethoxysilane (silane coupling agent) and 0.13 parts of acetic acid were charged into 11.2 parts of methyl acetate to produce a solution of vinyltrimethoxysilane in methyl acetate. Next, 100 parts of a PVA (raw material PVA) having a viscosity-average degree of polymerization of 1,000, a viscosity in a 4% by mass aqueous solution of 10 mPa·s, and a degree of saponification of 94 mol % were charged into a 1 L wide-mouthed eggplant-shaped flask, and the PVA was thereafter impregnated with the solution by spraying to give a mixture of vinyltrimethoxysilane with PVA. The eggplant-shaped flask was stored (heat treated) for 4 hrs in a hot air drier at 80° C. to give a modified PVA (12), being a reaction product of the raw material PVA and the vinyltrimethoxysilane. The modified PVA (12) thus obtained had a viscosity-average degree of polymerization of 1,000, a degree of saponification of 94 mol %, a degree of modification with the vinyltrimethoxysilane of 0.55 mol %, a dispersity A of 0.87, and a water-insoluble content of 60 ppm.

### Examples 11 to 17, Comparative Example 3

Modified PVAs (13) to (19) and PVA (X) were each produced similarly to Example 10, except that the type of the raw material PVA used, the type and the usage amount of the solvent, the type and the usage amount of the silane coupling agent, the type and the usage amount of the catalyst, and the production conditions (heat treatment conditions) were changed as shown in Table 3, and were evaluated on the physical properties thereof. The results are shown in Table 4.

### Production of Base Paper for Release Paper

Base papers for release paper were produced in accordance with the following procedure using each of the modified PVAs (12) to (19) and PVA (X) obtained in Examples 10 to 17 and Comparative Example 3, and were evaluated.

A 6% by mass aqueous solution of the modified PVA was produced and used as a coating liquid. Using a wire bar, this coating liquid was applied onto a glassine paper having an air resistance of 100 sec such that the coating amount had a dry mass of about 2.0 g/m². After the coating, drying was performed at 100° C. for 5 min to give a coated paper. The coated paper thus obtained was treated twice with a super calender at 70° C. and 400 kg/cm² to give a base paper for release paper. On this base paper for release paper was formed a coating layer derived from the coating liquid, i.e., a silicone filling layer.

### Evaluation of Air Resistance of Base Paper for Release Paper

The air resistance of the base paper for release paper was measured using an Oken-type air permeability tester in accordance with JIS-P8117-2009, and this air resistance was adopted as an indicator of silicone fillability in the base paper for release paper. The air resistance being higher indicates a tendency toward superiority in silicone fillability. The results are shown in Table 4.

### Evaluation of Silicone Curability

Using LTC 1056 L as addition-type silicone and SRX 212 as a platinum catalyst, each manufactured by Dow Corning Toray, mixing was performed such that a mass ratio of the addition-type silicone and platinum was 100/0.007 to prepare a solution. Using a blade coater, the solution thus obtained was applied on the silicone filling layer of the base paper for release paper obtained such that a solid content amount of the coating was 2.0 g/m². In this way, a silicone layer was formed on the base paper for release paper. Then, a heat treatment was performed at 110° C., and a time period until the silicone was cured was measured. The time period until the silicone was cured as referred to herein means a time period (sec) required until the silicone layer ceased peeling completely when the silicone layer was forcefully rubbed 10 times with a finger in intervals of a predetermined time period. The results are shown in Table 4.

### Evaluation of Adhesiveness of Release Layer

Using LTC 1056 L as addition-type silicone and SRX 212 as a platinum catalyst, each manufactured by Dow Corning Toray, mixing was performed such that a mass ratio of the addition-type silicone and the platinum was 100/0.009 to prepare a solution. Using a blade coater, the solution thus obtained was applied on the silicone filling layer of the base paper for release paper obtained such that a solid content amount of the coating was 2.0 g/m², and a heat treatment was performed at 110° C. for 90 sec to give a release paper in which a release layer (silicone layer) was formed on the base paper for release paper. The release paper thus obtained was evaluated in accordance with the following indicators. The results are shown in Table 4.

A⁺: Under conditions involving 40° C. and 90% RH, the release paper was left to stand for 1 week, and then the release layer forcefully rubbed with a finger. The result was that the release layer did not peel. The release paper was left to stand for 1 further week under the same conditions and then the release layer was forcefully rubbed with a finger. The result was that the release layer did not peel.

A: Under conditions involving 40° C. and 90% RH, the release paper was left to stand for 1 week, and then the release layer was forcefully rubbed with a finger. The result was that the release layer did not peel. However, when the release paper was left to stand for 1 further week under the same conditions and then the release layer was forcefully rubbed with a finger, the release layer peeled.

B: Under conditions involving 40° C. and 90% RH, the release paper was left to stand for 1 week, and then the release layer was forcefully rubbed with a finger. The result was that the release layer peeled.

C: Under conditions involving 40° C. and 90% RH, the release paper was left to stand for 1 week, and then the release layer was gently rubbed with a finger. The result was that the release layer peeled.

TABLE 3

| | | Raw Material PVA | | | | | | | | | Production Conditions | |
|---|---|---|---|---|---|---|---|---|---|---|---|---|
| | | Viscosity- | Viscosity in | Degree | Silane Coupling Agent | | | | | | Heat | Heat |
| | | average | 4% by mass | of | (Modification Type) | | Solvent | | Catalyst | | treatment | treatment |
| | | degree of | aqueous | saponi- | | Usage | | Usage | | Usage | temper- | time |
| | | polymer- | solution | fication | | amount | | amount | | amount | ature | period |
| | | ization | (mPa · s) | (mol %) | Type | (parts) | Type | (parts) | Type | (parts) | (° C.) | (hrs) |
| Example 10 | Modified | 1,000 | 10 | 94 | vinyltrimethoxy- | 4.8 | methyl | 11.2 | acetic | 0.13 | 80 | 4 |
| | PVA (12) | | | | silane | | acetate | | acid | | | |
| Example 11 | Modified | 1,000 | 10 | 94 | 3-methacryloxy- | 8.0 | methyl | 18.7 | acetic | 0.13 | 80 | 4 |
| | PVA (13) | | | | propyltrimethoxy- | | acetate | | acid | | | |
| | | | | | silane | | | | | | | |
| Example 12 | Modified | 1,000 | 12 | 98 | vinyltrimethoxy- | 5.0 | MeOH | 11.7 | acetic | 0.14 | 80 | 4 |
| | PVA (14) | | | | silane | | | | acid | | | |
| Example 13 | Modified | 1,000 | 9 | 75 | vinyltrimethoxy- | 4.1 | methyl | 9.6 | acetic | 0.12 | 80 | 4 |
| | PVA (15) | | | | silane | | acetate | | acid | | | |
| Example 14 | Modified | 2,400 | 44 | 88 | vinyltrimethoxy- | 4.5 | methyl | 10.5 | acetic | 0.13 | 80 | 4 |
| | PVA (16) | | | | silane | | acetate | | acid | | | |
| Example 15 | Modified | 500 | 5 | 94 | vinyltrimethoxy- | 4.8 | methyl | 11.2 | acetic | 0.13 | 80 | 4 |
| | PVA (17) | | | | silane | | acetate | | acid | | | |
| Example 16 | Modified | 200 | 2 | 94 | vinyltrimethoxy- | 4.8 | methyl | 11.2 | acetic | 0.13 | 80 | 4 |
| | PVA (18) | | | | silane | | acetate | | acid | | | |
| Example 17 | Modified | 100 | 1 | 94 | vinyltrimethoxy- | 4.8 | methyl | 11.2 | acetic | 0.13 | 80 | 4 |
| | PVA (19) | | | | silane | | acetate | | acid | | | |
| Comparative | PVA (X) | 1,000 | 10 | 94 | — | — | methyl | — | — | — | — | — |
| Example 3 | | | | | | | acetate | | | | | |

TABLE 4

| | Modified PVA | | | | | | | | |
|---|---|---|---|---|---|---|---|---|---|
| | | Viscosity- | | Degree | Degree | | Release Paper Evaluation | | |
| | | average | | of | of | Water- | Air | Silicone | |
| | | degree of | | saponi- | modifi- | insoluble | resis- | cur- | |
| | | polymer- | Dispersity | fication | cation | content | tance | ability | Adhesive- |
| | Type | ization | A | (mol %) | (mol %) | (ppm) | (sec) | (sec) | ness |
| Example 10 | Modified | 1,000 | 0.87 | 94 | 0.55 | 60 | 8,000 | 60 | A+ |
| | PVA (12) | | | | | | | | |
| Example 11 | Modified | 1,000 | 0.86 | 94 | 0.45 | 50 | 8,000 | 60 | A+ |
| | PVA (13) | | | | | | | | |
| Example 12 | Modified | 1,000 | 0.82 | 98 | 0.32 | 80 | 5,000 | 60 | A+ |
| | PVA (14) | | | | | | | | |
| Example 13 | Modified | 1,000 | 0.98 | 75 | 0.65 | <10 | 12,000 | 60 | A |
| | PVA (15) | | | | | | | | |
| Example 14 | Modified | 2,400 | 0.92 | 88 | 0.51 | 30 | 10,000 | 60 | A+ |
| | PVA (16) | | | | | | | | |
| Example 15 | Modified | 500 | 0.86 | 94 | 0.54 | 55 | 4,000 | 60 | A |
| | PVA (17) | | | | | | | | |
| Example 16 | Modified | 200 | 0.88 | 94 | 0.56 | 50 | 3,000 | 60 | B |
| | PVA (18) | | | | | | | | |
| Example 17 | Modified | 100 | 0.89 | 94 | 0.53 | 40 | 500 | 60 | B |
| | PVA (19) | | | | | | | | |
| Comparative | PVA (X) | 1,000 | — | 94 | — | <10 | 8,000 | >120 | C |
| Example 3 | | | | | | | | | |

As shown in Table 4, while Examples 10 to 17 were superior in silicone curability and adhesiveness, Comparative Example 3 was inferior in silicone curability and adhesiveness. Furthermore, Examples 13 and 14 were also superior in air resistance (fillability).

### Example 18

In a 100 mL beaker, 4.0 parts of vinyltrimethoxysilane (silane coupling agent) and 0.11 parts of acetic acid were charged into 9.3 parts of methyl acetate to produce a solution of vinyltrimethoxysilane in methyl acetate. Next, 100 parts of a PVA (raw material PVA) having a viscosity-average degree of polymerization of 750, a viscosity in a 4% by mass aqueous solution of 8 mPa·s, and a degree of saponification of 72 mol % were charged into a 1 L wide-mouthed eggplant-shaped flask, and the PVA was thereafter impregnated with the solution by spraying to give a mixture of vinyltrimethoxysilane with PVA. The eggplant-shaped flask was stored (heat treated) for 4 hrs in a hot air drier at 80° C. to give a modified PVA (20), being a reaction product of the raw material PVA and the vinyltrimethoxysilane. The modified PVA (20) thus obtained had a viscosity-average degree of polymerization of 750, a degree of saponification of 72 mol %, a degree of modification with the vinyltrimethoxysilane of 0.5 mol %, a dispersity A of 0.98, and a water-insoluble content of less than 10 ppm.

### Examples 19 to 24, Comparative Example 4

Modified PVAs (21) to (26) and PVA (Y) were each produced similarly to Example 18, except that the type of the raw material PVA used, the type and the usage amount of the solvent, the type and the usage amount of the silane coupling agent, the type and the usage amount of the catalyst, and the production conditions (heat treatment conditions) were changed as shown in Table 5, and were evaluated on the physical properties thereof. The results are shown in Table 6.

### Evaluation of Vinyl Polymer

Particles of vinyl chloride, being the vinyl polymer, were obtained by using each of the modified PVAs (20) to (26) obtained in Examples 18 to 24 and PVA (Y) obtained in Comparative Example 4 as a dispersant for suspension polymerization, in accordance with the following procedure.

Into an autoclave having a volume of 5 L was charged 1,390 g of an aqueous liquid, containing 0.94 g of one of the above-described dispersants for suspension polymerization (1,000 ppm with respect to the vinyl chloride monomer) dissolved therein. Next, 1.5 g of a 70% toluene solution of diisopropyl peroxydicarbonate was charged into the autoclave. Degassing was performed to remove oxygen until a pressure inside the autoclave was 0.0067 MPa. Thereafter, 940 g of vinyl chloride was charged thereinto, a temperature of the contents inside the autoclave was elevated to 57° C., and suspension polymerization was started under stirring. The pressure inside the autoclave at the time of the start of the polymerization was 0.83 MPa. The polymerization was terminated at a point of time 4 hrs after the start of the suspension polymerization when the pressure inside the autoclave had reached 0.65 MPa, and unreacted vinyl chloride was removed. Thereafter, a polymerization slurry was removed, and drying was performed overnight at 65° C. to give vinyl chloride polymer particles.

The vinyl chloride polymer particles (particles of the vinyl polymer) thus obtained were evaluated on the average particle diameter (or MGS (mean grain size)), the amount of coarse particles, and the fisheyes in accordance with the following procedures. The results are shown in Table 6.

### Evaluation Procedures

### (1) Average Particle Diameter (μm)

A JIS standard sieve was used to measure a particle size distribution by a dry sieve procedure disclosed in JIS-Z8815-1994. The result was plotted in accordance with the Rosin-Rammler distribution equation to calculate the average particle diameter (dp50).

### (2) Content of Coarse Particles (%)

A content (% by mass) of the vinyl chloride polymer particles which did not pass through a sieve having a mesh opening size of 355 μm (in terms of mesh of a JIS-standard sieve, 42 mesh) was evaluated in accordance with the following evaluation standard. The content means a total on the sieve (%). Furthermore, the mesh opening size of the sieve was in conformance with a nominal mesh opening size W disclosed in JIS-Z8801-1-2006.
A⁺: Less than 0.5% by mass
A: 0.5% by mass or more, and less than 1.0% by mass
B: 1.0% by mass or more, and less than 2.5% by mass
C: 2.5% by mass or more

### (3) Fisheyes (Number)

One hundred parts of the vinyl chloride polymer particles, 50 parts of dioctyl phthalate, 5 parts of tribasic lead sulfate, and 1 part of lead stearate were roll-kneaded at 150° C. for 7 min, 5 sheets of 1,400 mm×1,400 mm having a thickness of 0.1 mm were produced, and the number of fisheyes was visually counted. The counted number was converted into the number of fisheyes per 1.000 cm², and evaluated in accordance with the following standard. The fisheyes being fewer in number indicates fewer defects on the sheet.
A⁺: 0) to 5
A: 6 to 10
B: 11 to 49
C: 50 or more

TABLE 5

| | | Raw Material PVA | | | | | | | | | Production Conditions | |
|---|---|---|---|---|---|---|---|---|---|---|---|---|
| | | | Viscosity | | | | | | | | Heat | Heat |
| | | Viscosity- | in 4% by | Degree | Silane Coupling Agent | | | | | | treat- | treat- |
| | | average | mass | of | (Modification Type) | | Solvent | | Catalyst | | ment | ment |
| | | degree of | aqueous | saponi- | | Usage | | Usage | | Usage | temper- | time |
| | | polymer- | solution | fication | | amount | | amount | | amount | ature | period |
| | | ization | (mPa · s) | (mol %) | Type | (parts) | Type | (parts) | Type | (parts) | (° C.) | (hrs) |
| Example 18 | Modified | 750 | 8 | 72 | vinyltrimethoxy- | 4.0 | methyl | 9.3 | acetic | 0.11 | 80 | 4 |
| | PVA (20) | | | | silane | | acetate | | acid | | | |
| Example 19 | Modified | 750 | 8 | 72 | 3-methacryloxy- | 3.0 | methyl | 7.0 | acetic | 0.11 | 80 | 4 |
| | PVA (21) | | | | propyltrimethoxy- | | acetate | | acid | | | |
| | | | | | silane | | | | | | | |
| Example 20 | Modified | 750 | 8 | 72 | 3-mercaptopropyl- | 5.5 | methyl | 12.8 | acetic | 0.11 | 70 | 4 |
| | PVA (22) | | | | trimethoxysilane | | acetate | | acid | | | |
| Example 21 | Modified | 300 | 3 | 80 | vinyltrimethoxy- | 4.3 | methyl | 10.0 | acetic | 0.12 | 80 | 4 |
| | PVA (23) | | | | silane | | acetate | | acid | | | |
| Example 22 | Modified | 2,400 | 40 | 80 | vinyltrimethoxy- | 4.3 | methyl | 10.0 | acetic | 0.12 | 80 | 4 |
| | PVA (24) | | | | silane | | acetate | | acid | | | |
| Example 23 | Modified | 700 | 8 | 92 | vinyltrimethoxy- | 2.5 | methyl | 5.8 | acetic | 0.13 | 80 | 4 |
| | PVA (25) | | | | silane | | acetate | | acid | | | |
| Example 24 | Modified | 500 | 5 | 50 | vinyltrimethoxy- | 2.5 | MeOH | 5.8 | acetic | 0.10 | 80 | 4 |
| | PVA (26) | | | | silane | | | | acid | | | |
| Comparative | PVA (Y) | 750 | 8 | 72 | — | — | MeOH | 0.0 | acetic | 0 | 80 | 4 |
| Example 4 | | | | | | | | | acid | | | |

TABLE 6

| | Dispersant (Modified PVA) | | | | | | | | |
|---|---|---|---|---|---|---|---|---|---|
| | | Viscosity- | | Degree | Degree | | Vinyl Polymer Evaluation | | |
| | | average | | of | of | Water- | Average | Coarse | |
| | | degree of | | saponi- | modifi- | insoluble | particle | particle | |
| | | polymer- | Dispersity | fication | cation | content | diameter | amount | Fisheyes |
| | Type | ization | A | (mol %) | (mol %) | (ppm) | (μm) | (%) | (number) |
| Example 18 | Modified | 750 | 0.98 | 72 | 0.5 | <10 | 140 | A+ | A+ |
| | PVA (20) | | | | | | | | |
| Example 19 | Modified | 750 | 0.97 | 72 | 0.2 | <10 | 145 | A+ | A+ |
| | PVA (21) | | | | | | | | |
| Example 20 | Modified | 750 | 0.96 | 72 | 0.8 | 30 | 150 | A+ | A+ |
| | PVA (22) | | | | | | | | |
| Example 21 | Modified | 300 | 0.95 | 80 | 0.5 | <10 | 165 | B | A+ |
| | PVA (23) | | | | | | | | |
| Example 22 | Modified | 2,400 | 0.96 | 80 | 0.5 | <10 | 140 | A+ | B |
| | PVA (24) | | | | | | | | |
| Example 23 | Modified | 700 | 0.88 | 92 | 0.3 | 50 | 150 | A+ | A |
| | PVA (25) | | | | | | | | |
| Example 24 | Modified | 500 | 0.85 | 50 | 0.5 | 40 | 170 | A | A+ |
| | PVA (26) | | | | | | | | |
| Comparative | PVA (Y) | 750 | — | 72 | 0.0 | <10 | 220 | C | C |
| Example 4 | | | | | | | | | |

As shown in Table 6, in the cases of using the modified PVAs (20) to (26) of Examples 18 to 24 as the dispersant, a high-quality vinyl chloride polymer resin was obtained in which the average particle diameter of the particles of the vinyl polymer obtained was small, and the coarse particles and the fisheyes were few in number.

### INDUSTRIAL APPLICABILITY

The modified PVA of the present disclosure is superior in water solubility and has superior handleability while having a silane coupling agent-derived functional group. Thus, the modified PVA of the present disclosure can be used in various intended usages such as usages as a dispersant, a coating material, an adhesive, and a binder, and an industrial usage value thereof is extremely high.

1. A modified vinyl alcohol polymer comprising a structural unit represented by the following formula (1), and having a water-insoluble content of 1,000 ppm or less, 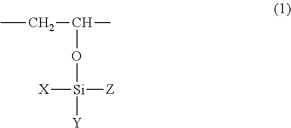
wherein, in the formula (1),
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and comprising an epoxy group, a group having 3 to 20 carbon atoms and comprising an acrylamide group, a group having 4 to 20 carbon atoms and comprising a methacrylamide group, an acetoxy group, or a group represented by —(CH₂)ₙ—O—R¹ (wherein R¹ represents a hydrogen atom, an alkali metal atom, an alkaline earth metal atom, an alkyl group having 1 to 20 carbon atoms, an alkenyl group having 2 to 20 carbon atoms, an acryloyl group, a methacryloyl group, or a glycidyl group; and n represents an integer of 0 to 6).

2. The modified vinyl alcohol polymer according to claim 1, wherein a content of the structural unit represented by the above formula (1) is 0.01 mol % or more and less than 5 mol %.

3. The modified vinyl alcohol polymer according to claim 1, wherein a content of the structural unit represented by the above formula (1) with respect to total structural units comprising a silicon atom is 90 mol % or more.

4. A method for producing a modified vinyl alcohol polymer according to claim 1, the method comprising impregnating, with a silane coupling agent, a vinyl alcohol polymer that is in a solid state.

5. The method for producing a modified vinyl alcohol polymer according to claim 4, wherein in the impregnating, particles of the vinyl alcohol polymer are impregnated by spraying a solution comprising the silane coupling agent.

6. The method for producing a modified vinyl alcohol polymer according to claim 4, wherein the silane coupling agent comprises a structure represented by the following formula (2), 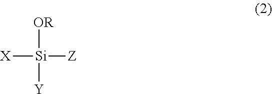
wherein, in the formula (2),
R represents an alkyl group having 1 to 8 carbon atoms, an acetyl group, or —(CH₂)ₘ—O—R² (wherein R² represents an alkyl group having 1 to 20 carbon atoms, and m represents an integer of 1 to 6); and
X, Y, and Z each independently represent an alkyl group having 1 to 20 carbon atoms, an alkenyl group having 2 to 20 carbon atoms, a phenyl group, a benzyl group, a vinylphenyl group, a halogenated alkyl group having 1 to 20 carbon atoms, a halogenated phenyl group, an aminoalkyl group having 1 to 20 carbon atoms, a mercaptoalkyl group having 1 to 20 carbon atoms, an ureidoalkyl group having 2 to 20 carbon atoms, an isocyanate alkyl group having 2 to 8 carbon atoms, a group having 3 to 20 carbon atoms and comprising an epoxy group, a group having 3 to 20 carbon atoms and comprising an acrylamide group, a group having 4 to 20 carbon atoms and comprising a methacrylamide group, an acetoxy group, or a group represented by —(CH₂)ₙ—O—R¹ (wherein R¹ represents an alkyl group having 1 to 20 carbon atoms, an alkenyl group having 2 to 20 carbon atoms, an acryloyl group, a methacryloyl group, or a glycidyl group; and n represents an integer of 0 to 6).

7. The method for producing a modified vinyl alcohol polymer according to claim 4, further comprising heat treating the vinyl alcohol polymer which is impregnated with the silane coupling agent and obtained in the impregnating.

8. Particles comprising the modified vinyl alcohol polymer according to claim 1.

9. The particles according to claim 8, wherein a dispersity A of silicon atoms is 0.2 or more and less than 1.

10. An aqueous solution comprising the modified vinyl alcohol polymer according to claim 1.

11. A coating liquid comprising a modified vinyl alcohol polymer according to claim 1.

12. The coating liquid according to claim 11, wherein a content of the structural unit represented by the above formula (1) in the modified vinyl alcohol polymer is 0.01 mol % or more and less than 5 mol %.

13. The coating liquid according to claim 11, wherein in the modified vinyl alcohol polymer, a content of the structural unit represented by the above formula (1) with respect to total structural units comprising a silicon atom is 90 mol % or more.

14. The coating liquid according to claim 11, wherein the modified vinyl alcohol polymer has a viscosity-average degree of polymerization of 500 or more and 5,000 or less, and a degree of saponification of 70 mol % or more and 99.9 mol % or less.

15. The coating liquid according to claim 11, wherein a water-insoluble content in the modified vinyl alcohol polymer in the coating liquid is 1,000 ppm or less.

16. A coated article comprising a base having the coating liquid according to claim 11 applied thereto.

17. A molded product comprising a layer comprising a modified vinyl alcohol polymer according to claim 1.

18. A release paper comprising:
a base;
a silicone filling layer; and
a release layer, wherein
the silicone filling layer comprises a modified vinyl alcohol polymer according to claim 1.

19. The release paper according to claim 18, wherein the release layer comprises addition-type silicone and platinum, and a content of the platinum with respect to 100 parts by mass of the addition-type silicone is 0.001 to 0.05 parts by mass.

20. A dispersant comprising a modified vinyl alcohol polymer according to claim 1.

21. The dispersant according to claim 20, wherein a content of the structural unit represented by the above formula (1) in the modified vinyl alcohol polymer is 0.01 mol % or more and less than 5 mol %.

22. The dispersant according to claim 20, wherein in the modified vinyl alcohol polymer, a content of the structural unit represented by the above formula (1) with respect to total structural units comprising a silicon atom is 90 mol % or more.

23. The dispersant according to claim 20, wherein the modified vinyl alcohol polymer has a viscosity-average degree of polymerization of 500 or more and 1,500 or less, and a degree of saponification of 60 mol % or more and 90 mol % or less.

24. The dispersant according to claim 20, wherein a water-insoluble content in the modified vinyl alcohol polymer is 1,000 ppm or less.

25. The dispersant according to claim 20, which is for use in suspension polymerization.

26. A method for producing a vinyl polymer, the method comprising subjecting a vinyl compound to suspension polymerization in the presence of the dispersant according to claim 20.

27. A mixture comprising:
a vinyl compound; and
the dispersant according to claim 20.
